(19) United States
(12) Patent Application Publication
(10) Pub. No.: US 2021/0213549 A1
(43) Pub. Date: Jul. 15, 2021

(54) DUST COLLECTING BOX FOR METALWORKING STATIONARY CUTTING MACHINE, AND METALWORKING STATIONARY CUTTING MACHINE

(71) Applicant: MAKITA CORPORATION, Anjo-shi, Aichi (JP)

(72) Inventors: Takenori MATSUI, Anjo-shi (JP); Kazuhiro SAKURAI, Anjo-shi (JP)

(73) Assignee: MAKITA CORPORATION, Anjo-shi, Aichi (JP)

(21) Appl. No.: 17/251,731

(22) PCT Filed: Jul. 25, 2019
(86) PCT No.: PCT/JP2019/029144

§ 371 Date: Dec. 11, 2020

(30) Foreign Application Priority Data
Sep. 3, 2018 (JP) 2018-164679
Apr. 22, 2019 (JP) 2019-081200

(51) Int. Cl. B23D 59/00; B24B 55/06; B24B 27/06

(52) U.S. Cl. CPC B23D 59/006; B24B 27/06; B24B 55/06

(57) ABSTRACT

A stationary cutting machine for metalworking, backflow of, for example, sparks toward an operator is prevented. A dust collector box is installable behind a cutting blade of a stationary cutting machine for metalworking for cutting a workpiece including a metal material. The dust collector box is installable adjacent to a placement surface for the workpiece. The dust collector box includes a dust collecting port that receives sparks generated during cutting of the workpiece, a dust collecting passage through which the sparks received at the dust collecting port are to flow rearward, and a guide that guides the sparks into the dust collecting passage and prevents the sparks entering the dust collecting passage from flowing back to the dust collecting port.

### FIELD

The present invention relates to a dust collector box for a stationary cutting machine for metalworking and to a stationary cutting machine for metalworking, and more particularly, to a dust collector box for a stationary cutting machine for metalworking and a stationary cutting machine for metalworking that prevent scattering of sparks generated during cutting of workpieces (steel materials such as iron pipes and steel channels) with the cutting machine.

### BACKGROUND

A known technique described in Japanese Unexamined Utility Model Application Publication No. 2-150151 (hereafter referred to as Patent Literature 1) relates to a dust collector box that prevents scattering of sparks generated during cutting of workpieces with a stationary cutting machine for metalworking. As shown in FIG. 48, which corresponds to FIG. 1 in

Patent Literature 1, a known dust collector box 202 has a rear wall 236 sloping down from the front to the rear. As indicated by arrow a, a flow of sparks hitting the sloping rear wall 236 is reflected downward to reduce blowback (backflow) of the sparks toward an operator, thus preventing the working environment from deteriorating.

### BRIEF SUMMARY

### Technical Problem

However, the dust collector box 202 described in Patent Literature 1 may cause the spark flow indicated by arrow a, hitting the rear wall 236, to partially flow back toward the operator. The blowback is to be reduced more reliably.

One or more aspects of the present invention are directed to a dust collector box for a stationary cutting machine for metalworking and a stationary cutting machine for metalworking that can more reliably reduce or prevent blowback of sparks toward an operator during cutting of workpieces with the cutting machine.

### Solution to Problem

A first aspect of the present invention provides a dust collector box installable behind a cutting blade of a stationary cutting machine for metalworking for cutting a workpiece including a metal material, the dust collector box being installable adjacent to a placement surface for the workpiece, the dust collector box including:

a dust collecting port configured to receive sparks generated during cutting of the workpiece;

a dust collecting passage through which the sparks received at the dust collecting port are to flow rearward; and

a guide configured to guide the sparks into the dust collecting passage, the guide being configured to prevent the sparks entering the dust collecting passage from flowing back to the dust collecting port.

A second aspect of the present invention provides a dust collector box installable behind a cutting blade of a stationary cutting machine for metalworking for cutting a workpiece including a metal material, the dust collector box being installable adjacent to a placement surface for the workpiece, the dust collector box including:

a dust collecting port configured to receive sparks generated during cutting of the workpiece;

a dust collecting passage through which the sparks received at the dust collecting port are to flow rearward;

a guide configured to guide the sparks into the dust collecting passage, the guide being configured to prevent the sparks entering the dust collecting passage from flowing back to the dust collecting port; and

a receiving portion configured to receive a body of the stationary cutting machine to avoid interference between the body and the dust collector box, the body including the cutting blade and being swingable, the receiving portion being covered in response to the body swinging for cutting.

A third aspect of the present invention provides a stationary cutting machine for metalworking, including:

a body including a circular cutting blade for cutting a workpiece including a metal material;

a base having a placement surface on which the workpiece is placeable; and

the dust collector box according to any one of the above aspects.

### Advantageous Effects

The dust collector box for a stationary cutting machine for metalworking and the stationary cutting machine for metalworking according to the above aspects of the present invention more reliably reduce or prevent blowback of sparks toward an operator during cutting of workpieces with the cutting machine.

### BRIEF DESCRIPTION OF DRAWINGS

FIG. 1 is a perspective view of a stationary cutting machine for metalworking with its body swung down and a dust collector box according to a first embodiment.

FIG. 2 is a plan view of the cutting machine with its body swung down and the dust collector box according to the first embodiment.

FIG. 3 is a right side view of the cutting machine with its body swung down and the dust collector box according to the first embodiment.

FIG. 4 is a perspective view of the cutting machine with its body swung up and the dust collector box according to the first embodiment.

FIG. 5 is a plan view of the cutting machine with its body swung up and the dust collector box according to the first embodiment.

FIG. 6 is a right side view of the cutting machine with its body swung up and the dust collector box according to the first embodiment.

FIG. 7 is a general perspective view of the dust collector box according to the first embodiment as viewed diagonally from the right rear and above.

FIG. 8 is an exploded perspective view of the dust collector box according to the first embodiment as viewed diagonally from the right front and below.

FIG. 9 is a plan view of the dust collector box according to the first embodiment.

FIG. 10 is a right side view of the dust collector box according to the first embodiment.

FIG. 11 is a front view of the dust collector box according to the first embodiment.

FIG. 12 is a right side view of the dust collector box according to the first embodiment schematically showing a spark flow.

FIG. 13 is a plan view of the dust collector box according to the first embodiment schematically showing a spark flow.

FIG. 14 is a perspective view of a cutting machine with its body swung down and a dust collector box according to a second embodiment as viewed diagonally from the right rear and above.

FIG. 15 is a plan view of the cutting machine with its body swung down and the dust collector box according to the second embodiment.

FIG. 16 is a right side view of the cutting machine with its body swung down and the dust collector box according to the second embodiment.

FIG. 17 is a perspective view of the cutting machine with its body swung up and the dust collector box according to the second embodiment as viewed diagonally from the right rear and above.

FIG. 18 is a plan view of the cutting machine with its body swung up and the dust collector box according to the second embodiment.

FIG. 19 is a right side view of the cutting machine with its body swung up and the dust collector box according to the second embodiment.

FIG. 20 is a general perspective view of the dust collector box according to the second embodiment as viewed diagonally from the right rear and above.

FIG. 21 is an exploded perspective view of the dust collector box according to the second embodiment as viewed diagonally from the right rear and above, with both covers detached.

FIG. 22 is a general perspective view of the dust collector box according to the second embodiment as viewed diagonally from the right rear and above, with a shield open and the covers being eliminated.

FIG. 23 is a general perspective view of the dust collector box according to the second embodiment as viewed diagonally from the left front and below, with the shield closed and the covers being eliminated.

FIG. 24 is a general perspective view of the dust collector box according to the second embodiment as viewed diagonally from the right front and above, with the shield closed and the covers being eliminated.

FIG. 25 is a plan view of the dust collector box according to the second embodiment, with the shield closed and the covers being eliminated.

FIG. 26 is a right side view of the dust collector box according to the second embodiment, with the shield closed and the covers being eliminated.

FIG. 27 is a front view of the dust collector box according to the second embodiment, with the shield closed and the covers being eliminated.

FIG. 28 is a development view of a first cover in the second embodiment.

FIG. 29 is a development view of a second cover in the second embodiment.

FIG. 30 is a right side view of the dust collector box according to the second embodiment schematically showing a spark flow.

FIG. 31 is a plan view of the dust collector box according to the second embodiment schematically showing a spark flow.

FIG. 32 is a perspective view of a dust collector box including a guide according to a third embodiment as viewed diagonally from the right front of the dust collecting port.

FIG. 33 is a plan view of the dust collector box including the guide according to the third embodiment.

FIG. 34 is a perspective view of a dust collector box including a guide according to a fourth embodiment as viewed diagonally from the right front of the dust collecting port.

FIG. 35 is a plan view of the dust collector box including the guide according to the fourth embodiment.

FIG. 36 is a perspective view of a dust collector box including a guide according to a fifth embodiment as viewed diagonally from the right front of the dust collecting port.

FIG. 37 is a plan view of the dust collector box including the guide according to the fifth embodiment.

FIG. 38 is a perspective view of a dust collector box including a guide according to a sixth embodiment as viewed diagonally from the right front of the dust collecting port.

FIG. 39 is a plan view of the dust collector box including the guide according to the sixth embodiment.

FIG. 40 is a perspective view of a dust collector box including a guide according to a seventh embodiment as viewed diagonally from the right front of the dust collecting port.

FIG. 41 is a plan view of the dust collector box including the guide according to the seventh embodiment.

FIG. 42 is a perspective view of a dust collector box including a guide according to an eighth embodiment as viewed diagonally from the right front of the dust collecting port.

FIG. 43 is a plan view of the dust collector box including the guide according to the eighth embodiment.

FIG. 44 is a perspective view of a dust collector box including a guide according to a ninth embodiment as viewed diagonally from the right front of the dust collecting port.

FIG. 45 is a plan view of the dust collector box including the guide according to the ninth embodiment.

FIG. 46 is a perspective view of a dust collector box including a guide according to a tenth embodiment as viewed diagonally from the right front of the dust collecting port.

FIG. 47 is a plan view of the dust collector box including the guide according to the tenth embodiment.

FIG. 48 is a side view of a known metal cutting machine in use with a debris collector attached.

### DETAILED DESCRIPTION

Embodiments of the present invention will now be described with reference to the drawings.

### First Embodiment

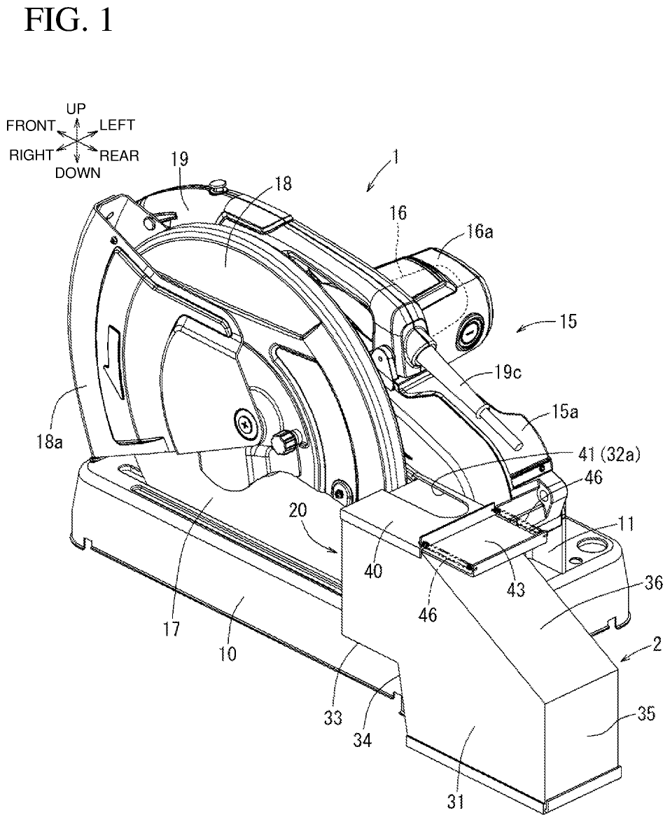

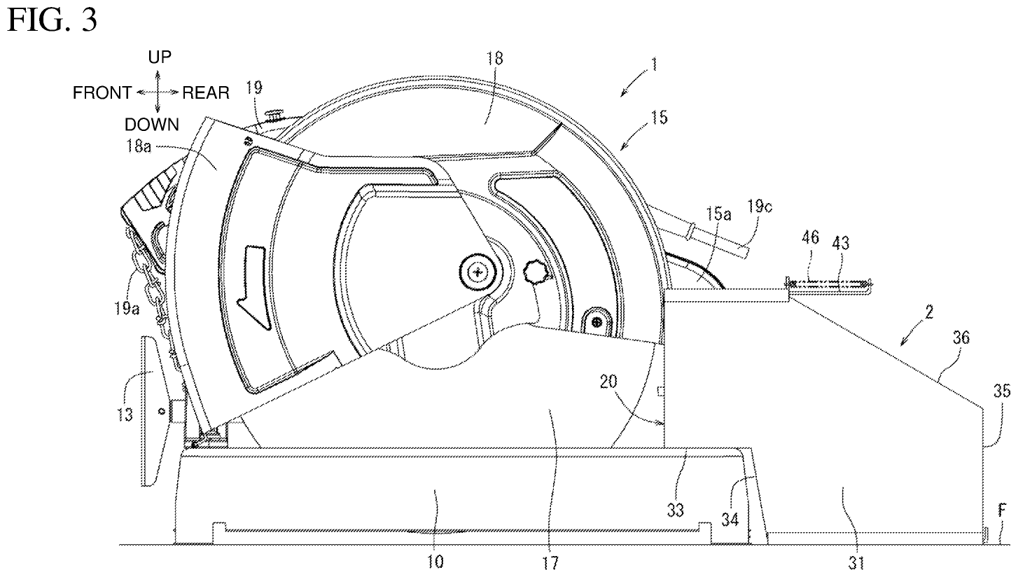

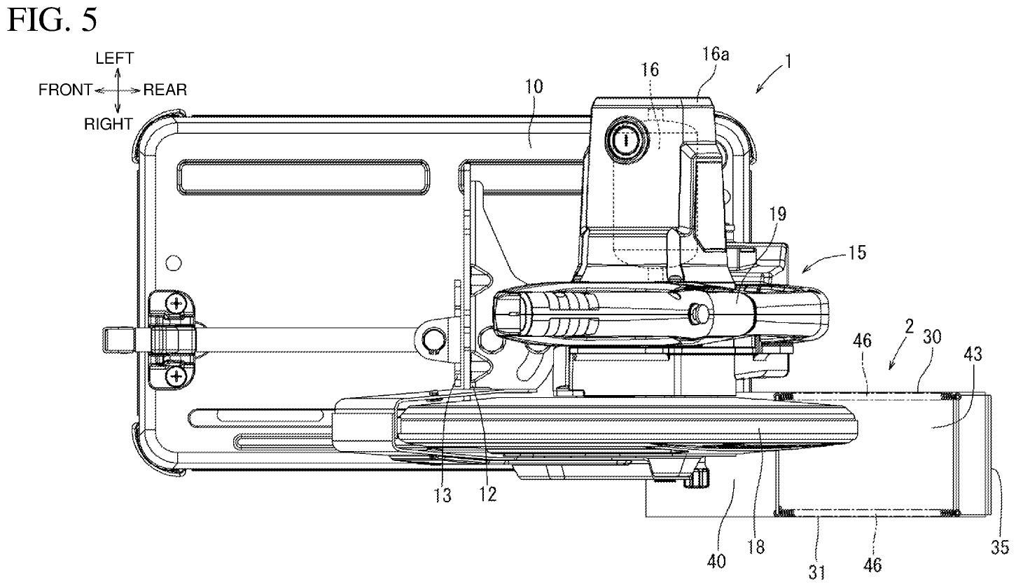

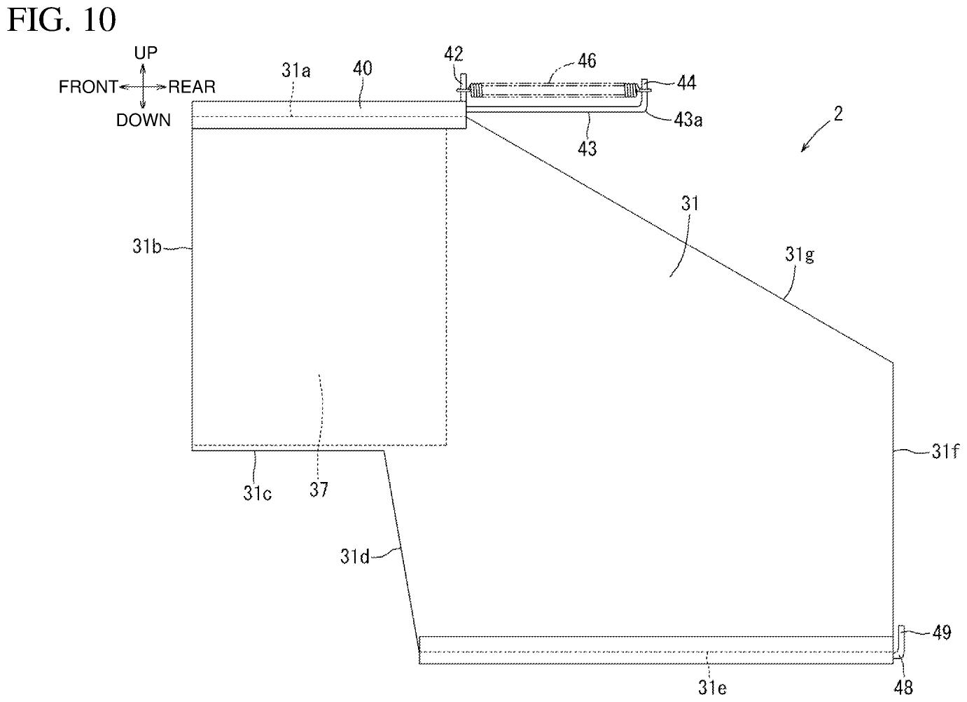

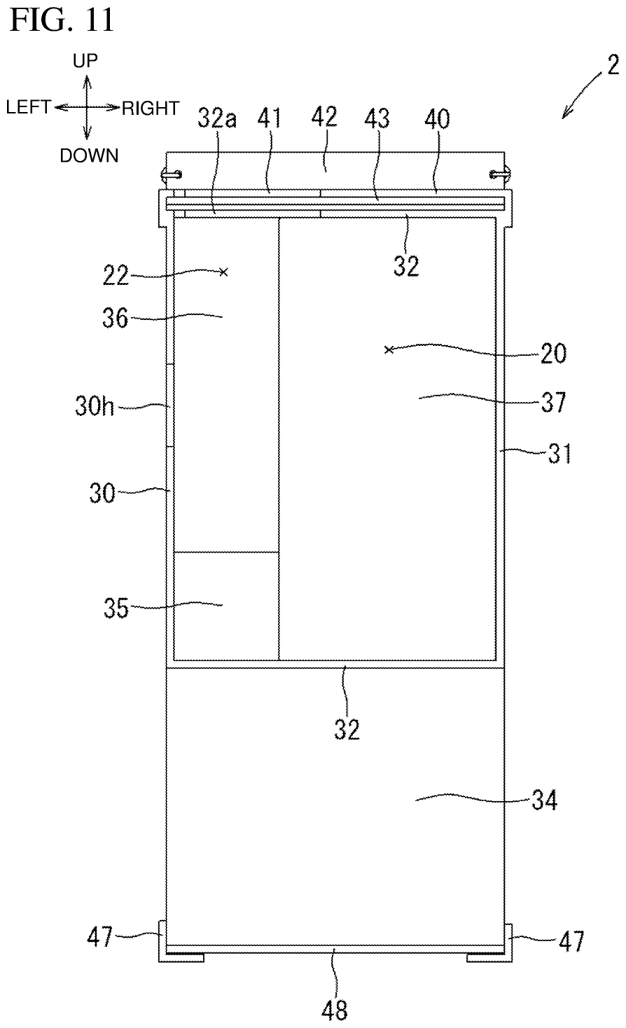

A stationary cutting machine for metalworking according to a first embodiment will now be described with reference to FIGS. 1 to 13. An operator performs cutting on the left of a stationary cutting machine (cutting machine) 1 for metalworking in FIG. 3. The directional terms, up and down (or vertical), front and rear (or forward and backward), and right and left (or lateral) used herein indicate positions or directions with respect to the operator. In other words, the front as viewed from the operator is defined as the front. The same applies to all the embodiments described below. The cutting machine 1 and a dust collector box 2 included in the cutting machine 1 are described separately below.

The cutting machine 1 will now be described. As shown in FIGS. 1 to 6, the cutting machine 1 includes a base 10, a support 11, and a body 15. The base 10 is installable on an installation floor F, such as a floor surface. The support 11 is fixed to the base 10. The body 15 is supported on the support 11 with a swing support shaft 14 to be vertically swingable with respect to the support 11. The body 15 includes a swing support 15a in the rear portion. The swing support 15a is coupled to the support 11 with the swing support shaft 14. Although not illustrated, a compression spring is between the support 11 and the swing support 15a to urge the body 15 to swing upward. The operator presses and swings down the body 15 against the compression spring to perform a cutting process. The operator stops pressing down the body 15 to return the body 15 upward with the urging force from the compression spring. The base 10 has a flat upper surface serving as a placement surface on which a workpiece is placeable.

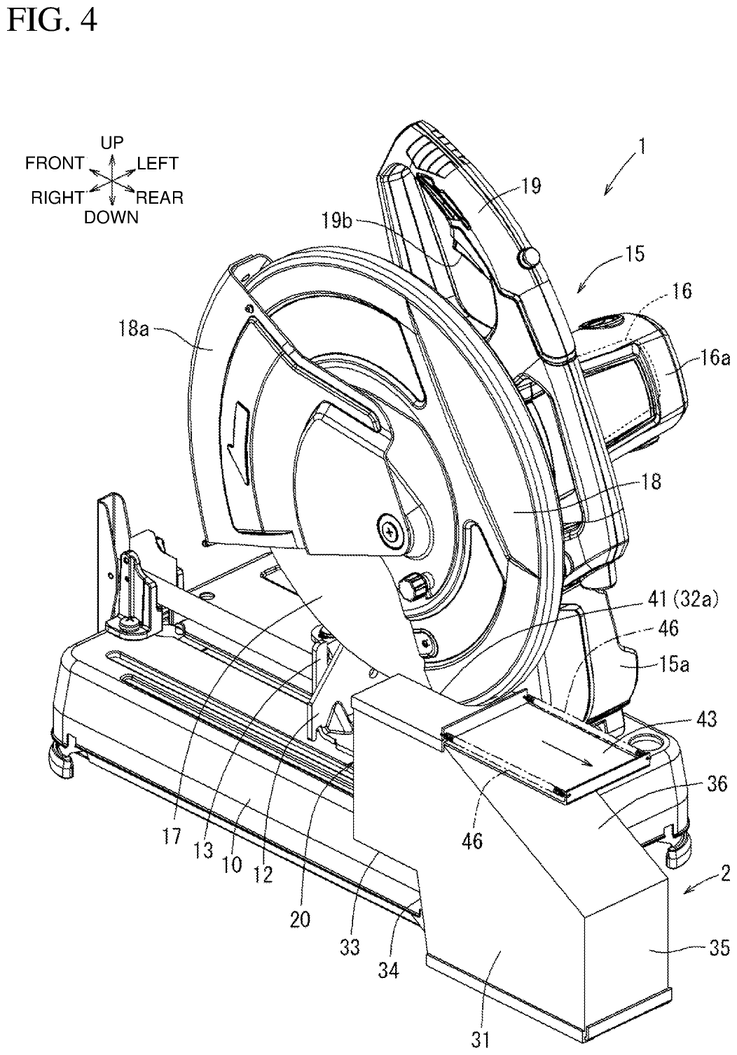

The body 15 includes an electric motor 16, a grinding disc 17, a fixed cover 18, and a handle 19. The electric motor 16, which is a drive source, is accommodated in a motor housing 16a. The grinding disc 17 is a circular cutting blade rotatable with the electric motor 16. The fixed cover 18 covers the upper part of the grinding disc 17. The handle 19 is grippable by the operator. The fixed cover 18 includes a movable cover 18a for covering the lower part of the grinding disc 17. The movable cover 18a is open and closed. As shown in FIG. 4, the handle 19 includes a switch lever 19b on a lower surface of the handle 19. The operator pulls the switch lever 19b with the fingers holding the handle 19 to activate the electric motor 16. The electric motor 16 is powered by an alternating current (AC) power source. The handle 19 has a rear portion receiving a power cable 19c.

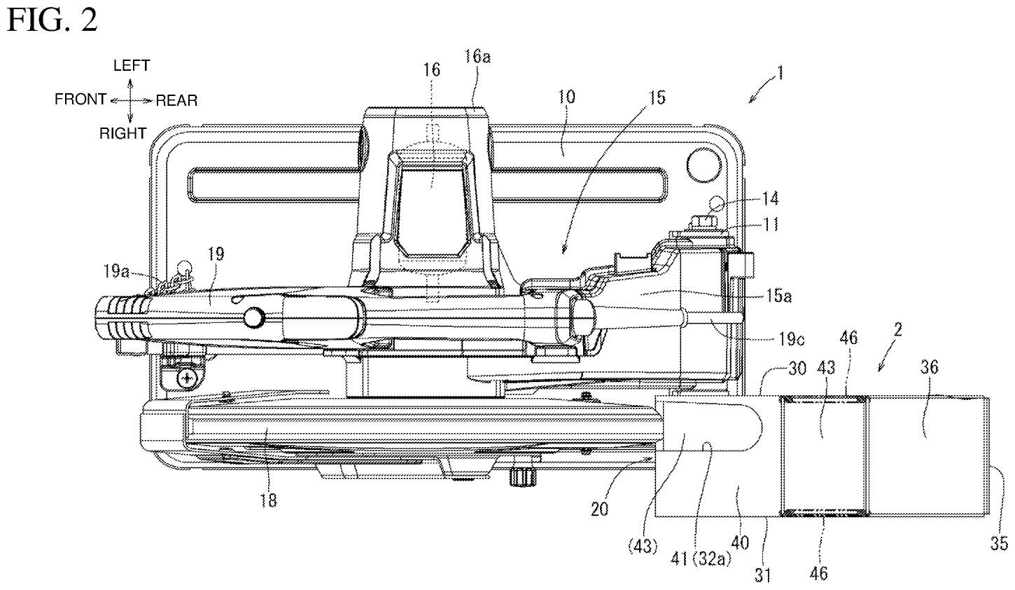

As shown in FIGS. 2 and 3, the base 10 and the handle 19 have front portions tethered together with a retaining chain 19a. The retaining chain 19a can hold the body 15 at a swung-down position. With the body 15 held at the swung-down position, the cutting machine 1 can be compact when being carried or stored. The base 10 has an upper surface receiving a fence 12 and a vise 13 assembled on the upper surface. A workpiece (metal material) such as an iron pipe is held and fixed between the fence 12 and the vise 13.

With the workpiece fixed on the base 10, the operator activates the electric motor 16 to rotate the grinding disc 17 and swings down the body 15. This allows the grinding disc 17 to cut into the workpiece for a cutting process. The cutting machine 1 is installed on the installation floor F. The cutting process causes chips mainly formed from sparks A to flow backward from a cutting site (a site at which the grinding disc 17 cuts into). The chips flowing backward (hereafter referred to as sparks A or a spark flow A) are collected into the dust collector box 2 described below.

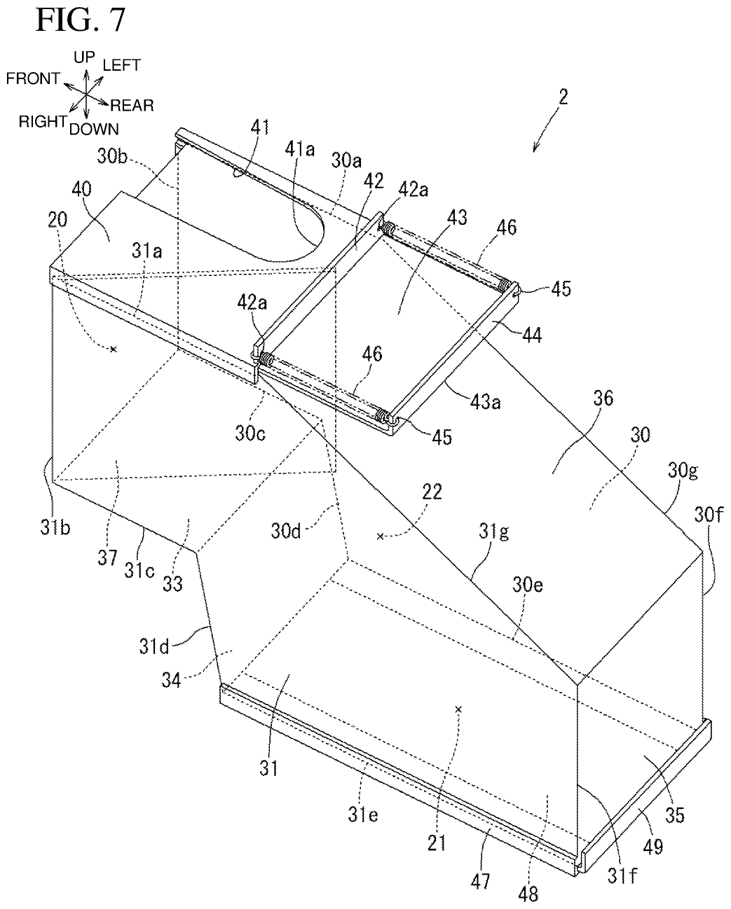

The dust collector box 2 will now be described. As shown in FIGS. 7 to 11, the dust collector box 2 is a substantially L-shaped box. The dust collector box 2 has a dust collecting port 20, an outlet port 21, and a dust collecting passage 22. The dust collector box 2 is installable adjacent to the placement surface of the base 10 behind a cutting site (a site at which sparks are generated by cutting). The dust collecting port 20 is a rectangular opening. The outlet port 21 is an opening through which dust can be discharged. The dust collecting passage 22 allows communication between the dust collecting port 20 and the outlet port 21. The dust collector box 2 is formed using several metal sheets (e.g., iron sheets). More specifically, the dust collector box 2 includes heptagonal left and right side walls 30 and 31, a rectangular upper wall 32, a rectangular lower wall 33, a rectangular recessed wall 34, a rectangular rear wall 35, and a rectangular sloping wall 36. The dust collector box 2 is formed using metal sheets. The dust collector box 2 has a weight to allow the dust collector box 2 to be installed on the installation floor F with the front portion of the dust collector box 2 mostly on the base 10. The dust collector box 2 can thus be easily detached and carried.

The upper wall 32 is welded to the left and right side walls 30 and 31 to extend between upper sides 30a and 31a of the left and right side walls 30 and 31. The lower wall 33 is welded to the left and right side walls 30 and 31 to extend between lower sides 30c and 31c of the left and right side walls 30 and 31. The recessed wall 34 is welded to the left and right side walls 30 and 31 to extend between recessed sides 30d and 31d of the left and right side walls 30 and 31. The rear wall 35 is welded to the left and right side walls 30 and 31 to extend between rear sides 30f and 31f of the left and right side walls 30 and 31. The sloping wall 36 is welded to the left and right side walls 30 and 31 to extend between sloping sides 30g and 31g of the left and right side walls 30 and 31.

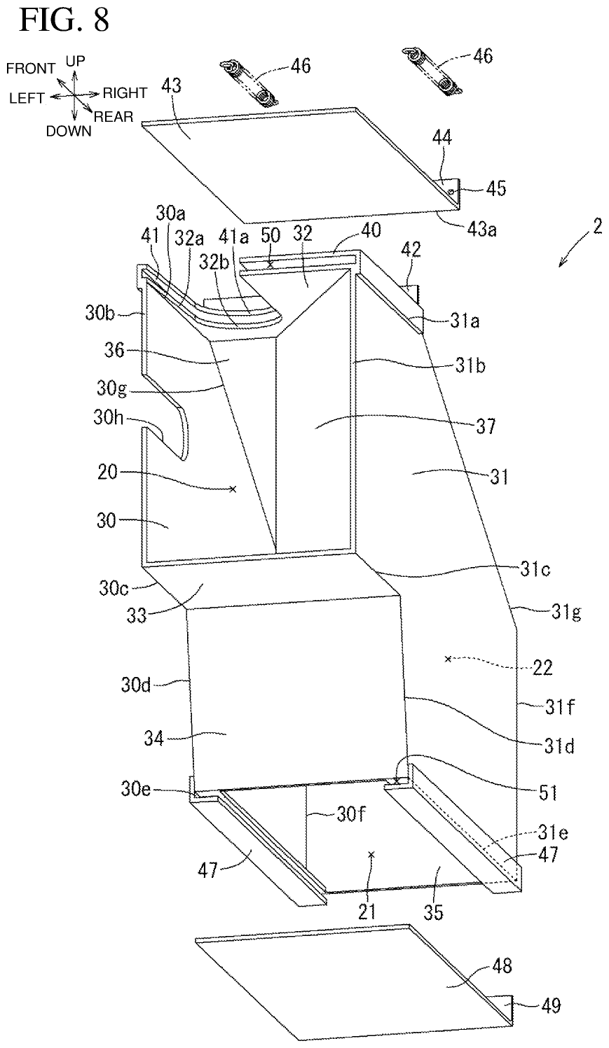

As clearly seen from FIG. 8, no wall extends between front sides 30b and 31b of the left and right side walls 30 and 31. In other words, the left and right side walls 30 and 31 define an opening or the dust collecting port 20 at the front sides 30b and 31b. Also, no wall extends between bottom sides 30e and 31e of the left and right side walls 30 and 31. In other words, the left and right side walls 30 and 31 define an opening or the outlet port 21 at the bottom sides 30e and 31e.

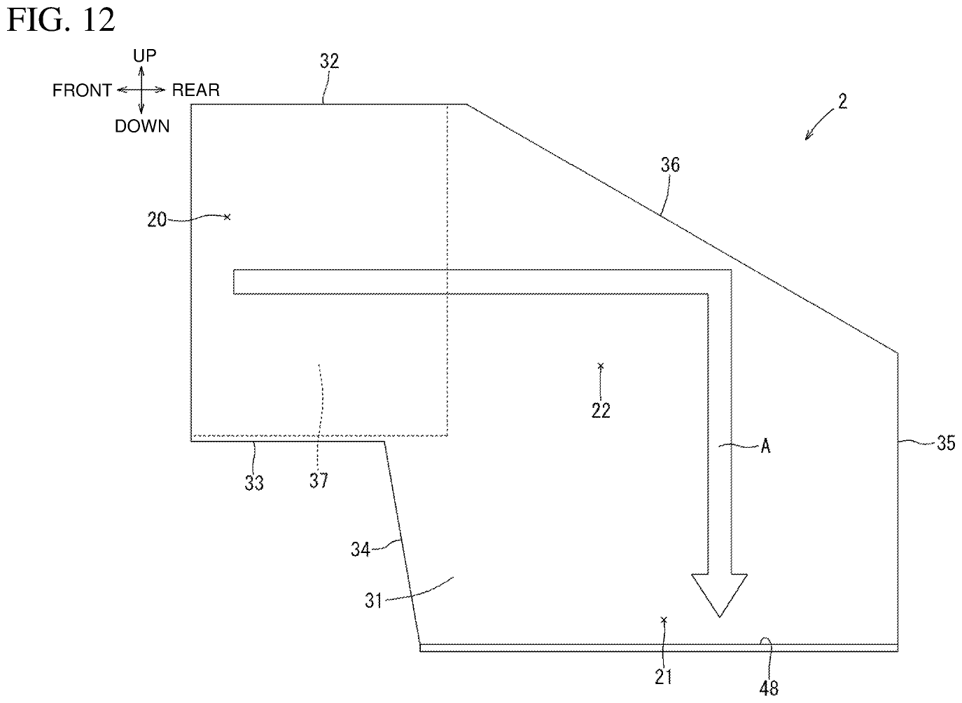

As clearly seen from FIGS. 7 and 12, the sloping wall 36 is located downstream from and opposed to the dust collecting port 20, and slopes down from the front to the rear. This structure allows sparks hitting the sloping wall 36 to be reflected downward. The left side wall 30 has an insertion slot 30h for receiving an end of the swing support shaft 14 of the cutting machine 1. Thus, the dust collector box 2 can be tightly fitted to the cutting machine 1.

The dust collector box 2 accommodates a guide wall (guide) 37 near the dust collecting port 20. The guide wall 37 guides sparks into the dust collecting passage 22. The guide wall 37 in the present embodiment is a single rectangular flat plate. The guide wall 37 extends from an inner surface 31h of the right side wall 31. The guide wall 37 is inclined to narrow the flow passage area of the dust collecting passage 22 downstream. In other words, the guide wall 37 guides the sparks A to smoothly flow downstream into the dust collecting passage 22, and obstructs upstream scattering of the sparks A (prevents backflow of the sparks A).

The guide wall 37 has a front edge welded to the inner surface 31h of the right side wall 31. The guide wall 37 is installed to have a rear edge inclined with respect to a straight line 22a indicating the extending direction of the dust collecting passage 22 in a plan view.

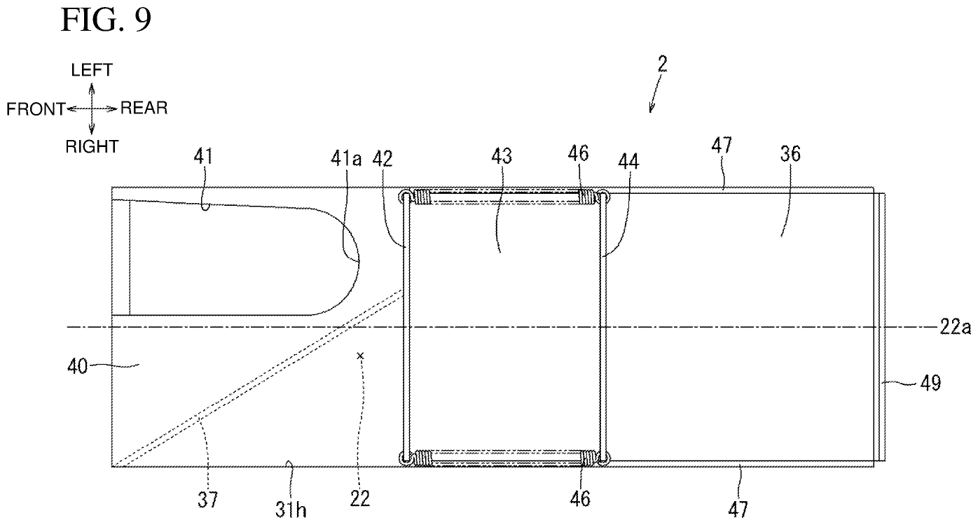

The guide wall 37 is a rectangular metal (e.g., iron) plate (refer to FIG. 9). The upper wall 32 has a receiving portion 32a for receiving the fixed cover 18 of the cutting machine 1. The receiving portion 32a is a cutout elongated from the front end of the upper wall 32. The receiving portion 32a receives the fixed cover 18 of the body 15 to avoid interference between the fixed cover 18 and the upper wall 32 of the dust collector box 2. The receiving portion 32a has an arc-shaped distal end along an arc transverse section of the fixed cover 18. In other words, the receiving portion 32a has a distal end including an arc portion 32b conforming to an arc transverse section of the fixed cover 18.

This structure creates no gap between the arc portion 32b and the fixed cover 18 received in the receiving portion 32a, thus preventing the sparks A from scattering through the receiving portion 32a. The dust collector box 2 includes an upper guide 40 above the upper wall 32 with a clearance 50 between them (refer to FIG. 8). The upper guide 40 also has a receiving portion 41 shaped in correspondence with the receiving portion 32a in the upper wall 32. The receiving portion 41 also has a distal end including an arc portion 41a shaped in correspondence with the arc portion 32b. The upper guide 40 has a rear edge including a stopper 42 that is bent upward.

The stopper 42 has spring-receiving holes 42a on the left and right. The clearance 50 receives an upper slide plate 43 from the rear to the front. The upper slide plate 43 is rectangular and slightly smaller than the upper wall 32. The upper slide plate 43 can thus cover the receiving portion 32a in the upper wall 32 to prevent the sparks A from scattering through the receiving portion 32a. The upper slide plate 43 has a rear edge including a bend 44 that is bent upward. The bend 44 has spring-receiving holes 45 on the left and right. The left spring-receiving holes 42a and 45 receive a tension spring 46. The right spring-receiving holes 42a and 45 receive a tension spring 46.

The tension springs 46 constantly retain the upper slide plate 43 to cover the receiving portion 32a in the upper wall 32. The dust collector box 2 includes a pair of lower guides 47 along the bottom sides 30e and 31e of the left and right side walls 30 and 31 with clearances 51 between the lower guides 47 and the bottom sides 30e and 31e. The clearances 51 receive a lower slide plate 48 from the rear to the front. The lower slide plate 48 is rectangular and slightly smaller than the lower wall 33. The lower slide plate 48 can thus cover the outlet port 21. The lower slide plate 48 has a rear edge including a bend 49 that is bent upward.

The dust collector box 2 according to the present embodiment is placed on the installation floor F adjacent to and on the right of the cutting machine 1, with the left side wall 30 having the insertion slot 30h receiving the end of the swing support shaft 14 of the cutting machine 1 (refer to FIGS. 4 to 6). The dust collector box 2 is thus attached to the cutting machine 1. In this state, the cutting machine 1 has the fixed cover 18 partially received (fitted) in the receiving portion 32a in the upper wall 32 of the dust collector box 2, with the upper slide plate 43 slid backward against the urging force from the tension springs 46.

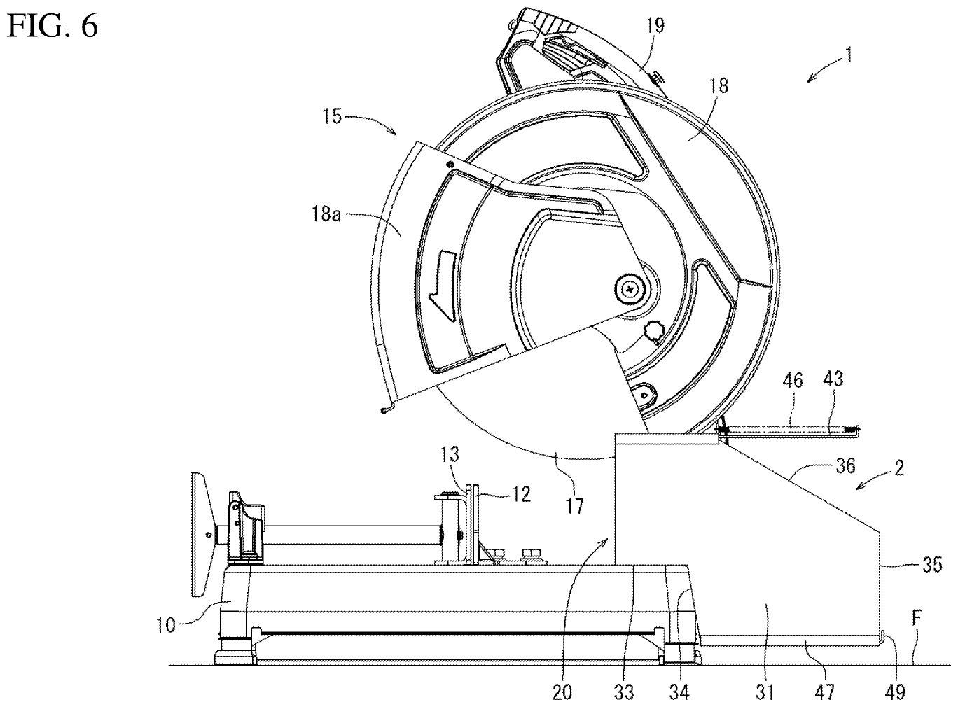

In other words, the cutting machine 1 has the fixed cover 18 partially entering (fitted in) the receiving portion 32a in the upper wall 32 of the dust collector box 2. Thus, the fixed cover 18 partially overlaps the upper wall 32 of the dust collector box 2 in a side view (refer to FIG. 6).

With this positional relationship, the upper slide plate 43 receives a restoring force of the tension springs 46 to cover the receiving portion 32a in the upper wall 32, and is thus pressed against the fixed cover 18 of the cutting machine 1 (refer to FIGS. 4 to 6). When the body 15 is pushed down, the fixed cover 18, which is received in the receiving portion 32a in the upper wall 32, starts partially exiting from the receiving portion 32a in the upper wall 32.

In other words, the receiving portion 32a in the upper wall 32 is open and closed as the body 15 swings.

The operation of the dust collector box 2 according to the present embodiment will now be described (refer to FIGS. 12 and 13). The workpiece held on the support 11 is cut with the rotating grinding disc 17 while generate sparks A, which then scatter through the dust collecting port 20 into the dust collecting passage 22. The scattering sparks A are guided along the guide wall 37 toward the sloping wall 36. The guided sparks A hit the sloping wall 36 and are reflected downward (refer to FIG. 12).

The reflected sparks A can accumulate near the outlet port 21, or more specifically, on the lower slide plate (dust collector) 48. The sparks A cool and solidify to form chips of, for example, iron oxide, upon, before, or after reaching the lower slide plate 48. The chips (not shown) resulting from the sparks A generated during cutting can be collected in this manner. The lower slide plate 48 is then slid backward to uncover the outlet port 21 to discharge the collected chips.

The sparks A hitting the sloping wall 36 may be partially reflected upstream (blow back) without being reflected downward. However, the guide wall 37 obstructs the dust collecting passage 22 to prevent backflow of the sparks A as described above (refer to FIG. 13). This prevents the sparks A, reflected upstream, from blowing back through the dust collecting port 20, and thus from blowing toward the operator.

The dust collector box 2 according to the present embodiment includes the guide wall 37 on the inner surface 31h of the right side wall 31. The guide wall 37 narrows the area of the dust collecting passage 22 (the longitudinal sectional area of the dust collecting passage 22) downstream in the dust collecting passage 22 (from the dust collecting port 20 to the outlet port 21). In other words, the guide wall 37 guides the sparks A to smoothly flow downstream into the dust collecting passage 22, and obstructs upstream scattering of the sparks A (prevents backflow of the sparks A). The guide wall 37 thus obstructs the sparks A returning upstream after being generated during cutting and reflected by the sloping wall 36. This prevents blowback of the sparks A toward the operator.

The guide wall 37 in the present embodiment is a rectangular metal (e.g., iron) plate.

The guide wall 37 has a front edge welded to the inner surface 31h. The guide wall 37 is installed to have a rear edge inclined with respect to the straight line 22a indicating the extending direction of the dust collecting passage 22 in a plan view. The guide wall 37 with this simple structure simplifies the structure of the dust collector box 2.

The cutting machine 1 according to the present embodiment includes the fixed cover 18 that partially overlaps the upper wall 32 of the dust collector box 2 in a side view. With this positional relationship, the upper slide plate 43 receives a restoring force of the tension springs 46 and is pressed against the fixed cover 18 of the cutting machine 1 (refer to FIGS. 4 to 6). When the body 15 is pushed down, the fixed cover 18, which is received in the receiving portion 32a in the upper wall 32, starts partially exiting from the receiving portion 32a in the0 upper wall 32. In other words, the receiving portion 32a in the upper wall 32 is open and closed as the body 15 swings. The upper slide plate 43 slides accordingly as the body 15 swings. The upper slide plate 43 thus covers a gap created in the receiving portion 32a in the upper wall 32 as the body 15 swings. The sparks A are prevented from scattering through the receiving portion 32a in the upper wall 32.

The tension springs 46 in the present embodiment constantly retain the upper slide plate 43 to cover the receiving portion 32a in the upper wall 32. Thus, the upper slide plate 43 with this simple structure can cover a gap created in the receiving portion 32a in the upper wall 32 as the body 15 swings.

In the dust collector box 2 according to the present embodiment, the sparks A hitting the sloping wall 36 and reflected downward can accumulate near the outlet port 21, or more specifically, on the lower slide plate 48. This allows collection of chips generated during cutting of the workpiece. The lower slide plate 48 is then slid backward to uncover the outlet port 21 to remove the collected chips.

The dust collector box 2 according to the present embodiment is attached to the cutting machine 1. The cutting machine 1 can thus prevent scattering of the sparks A generated during cutting of the workpiece. The cutting machine 1 can also prevent the sparks A from blowing back toward the operator during cutting.

### Second Embodiment

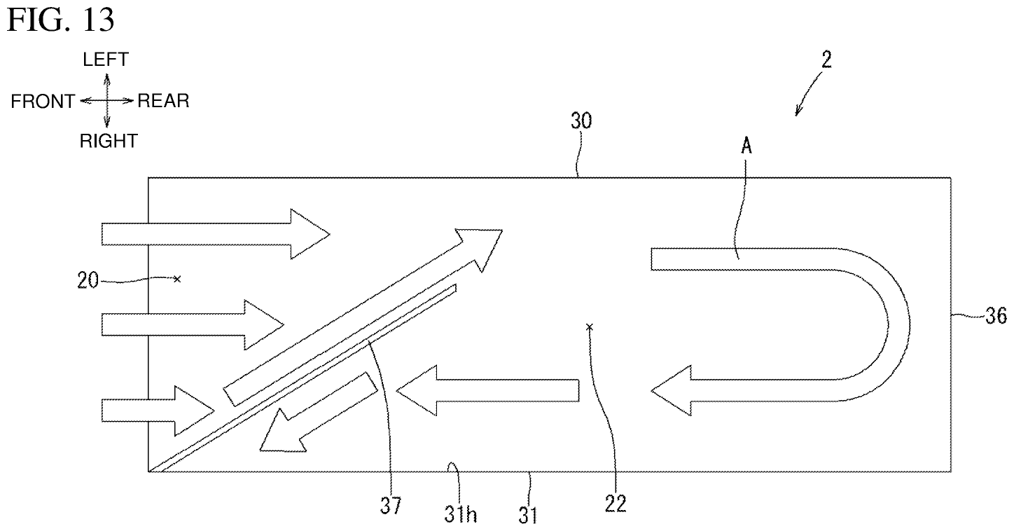

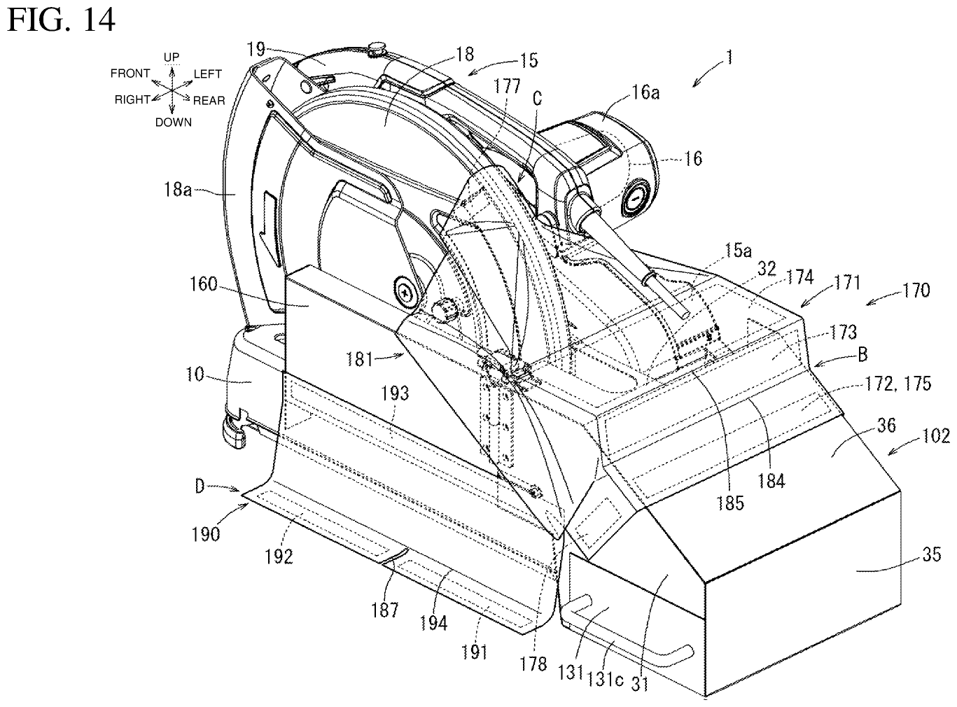

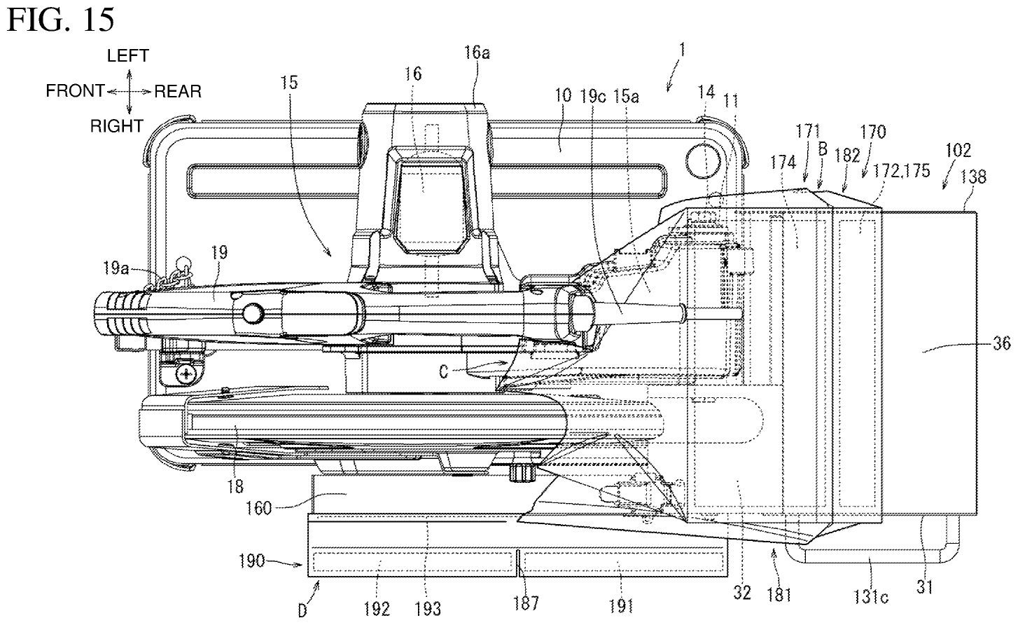

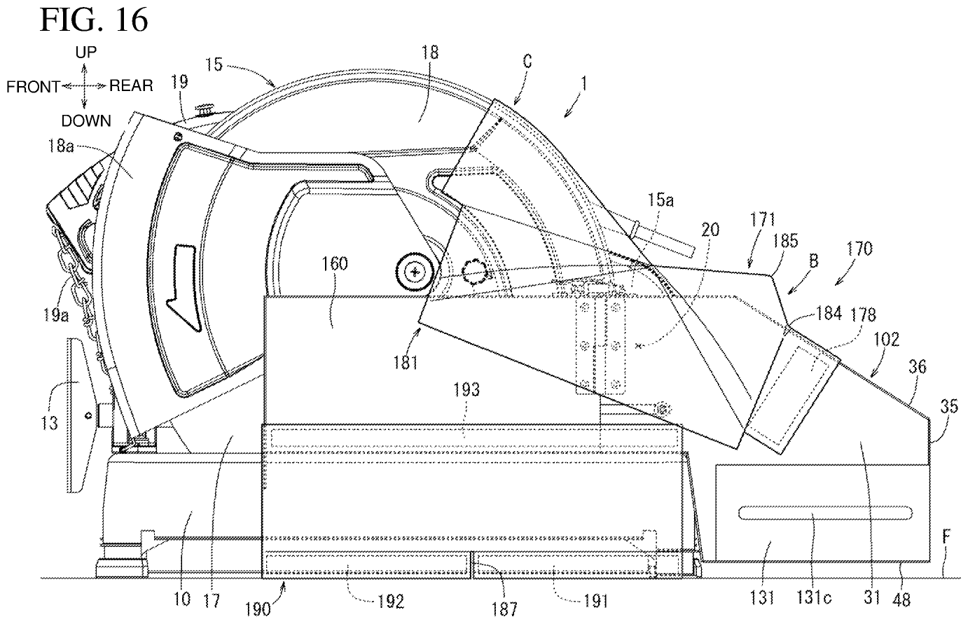

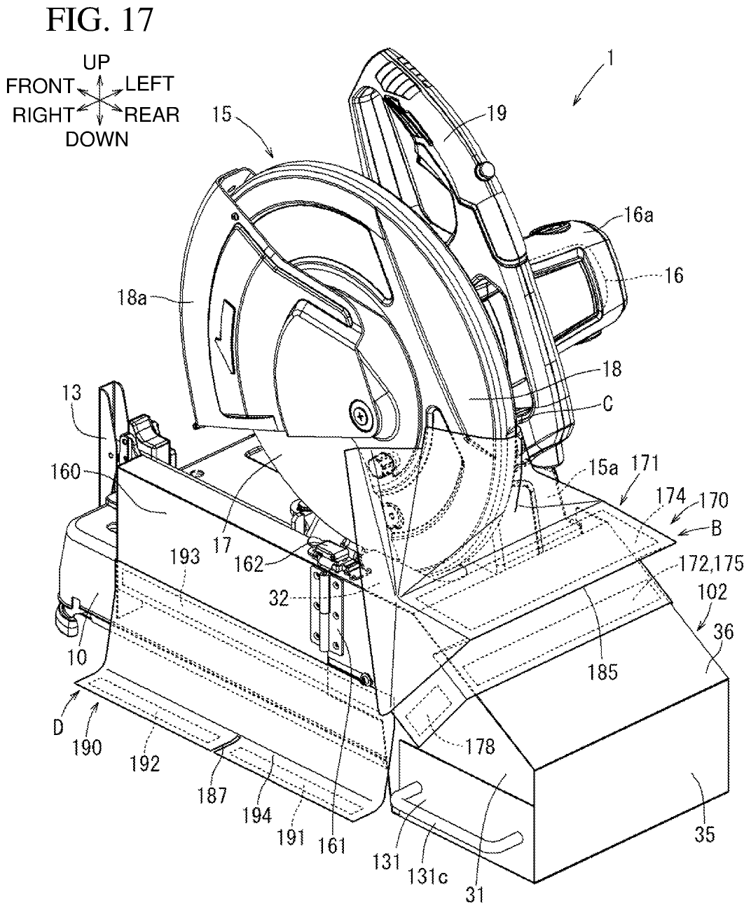

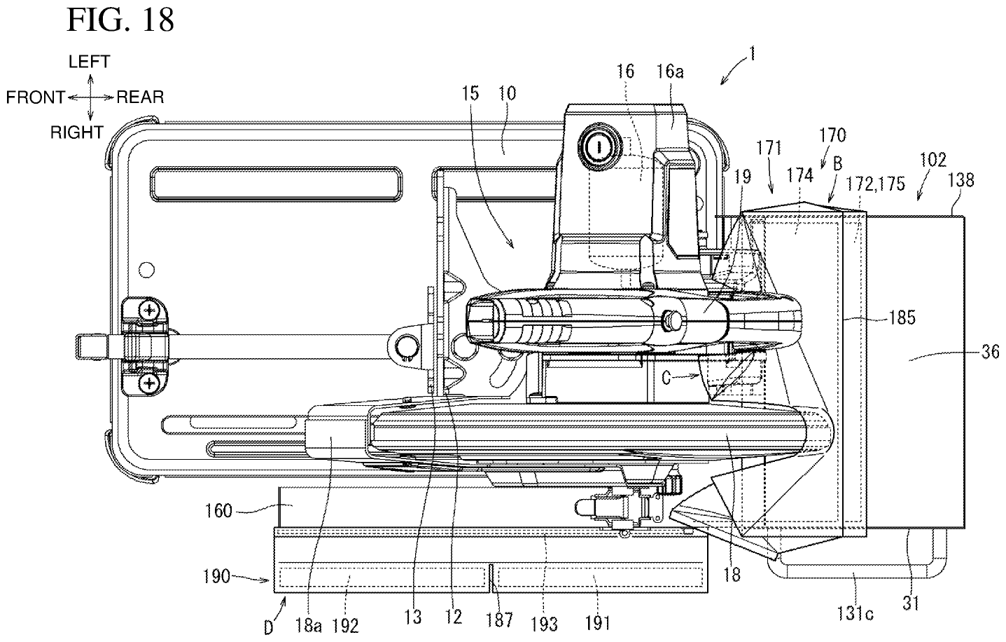

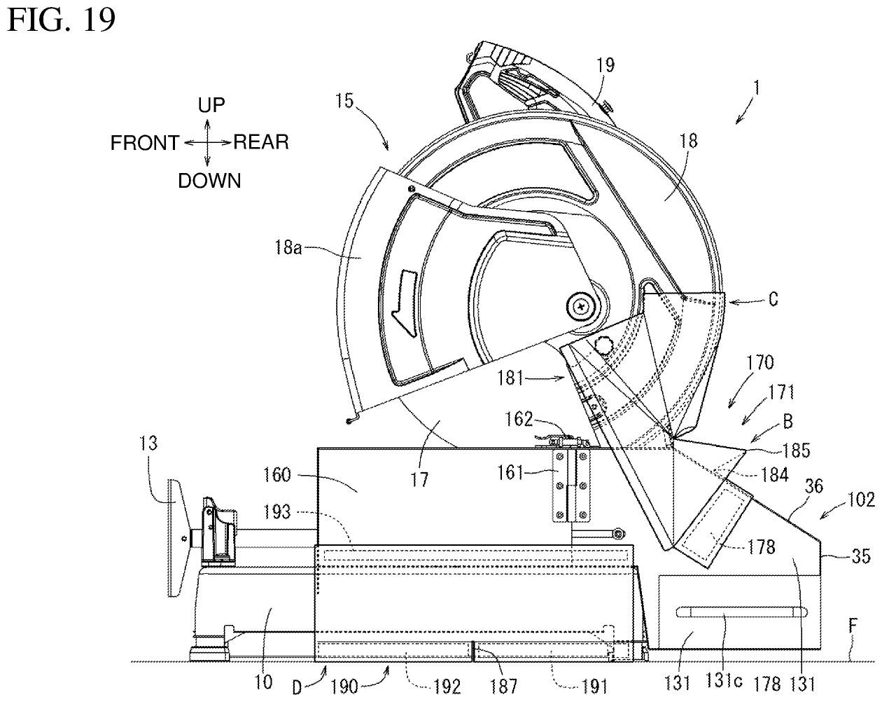

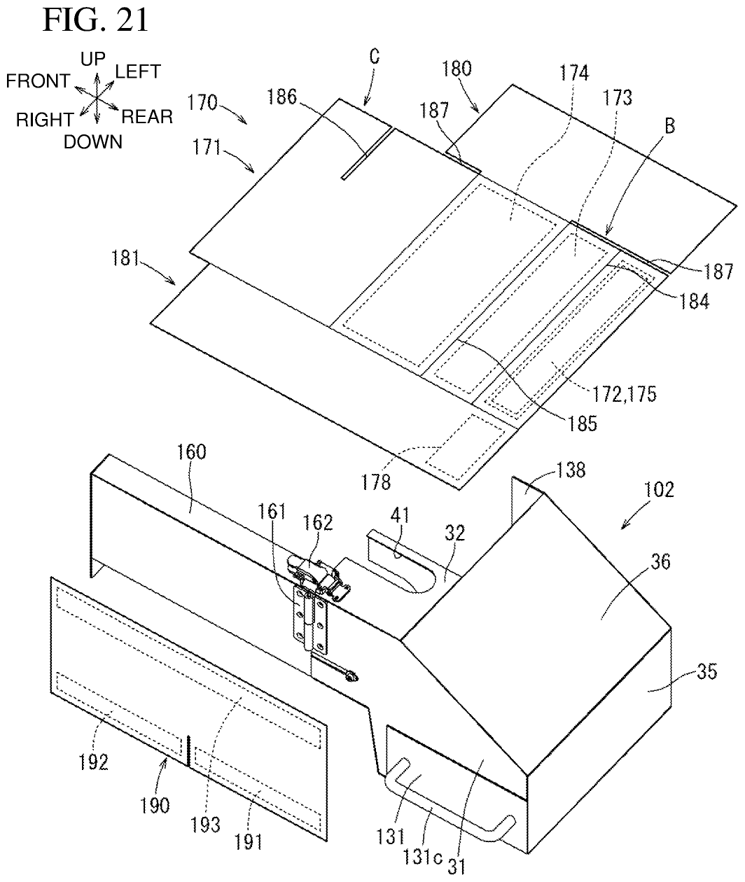

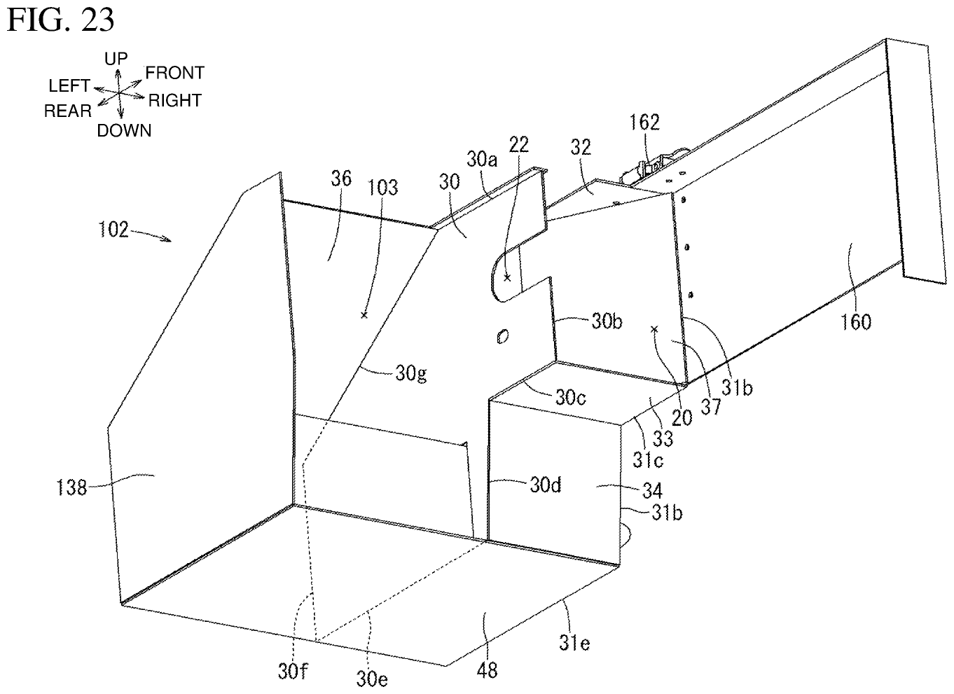

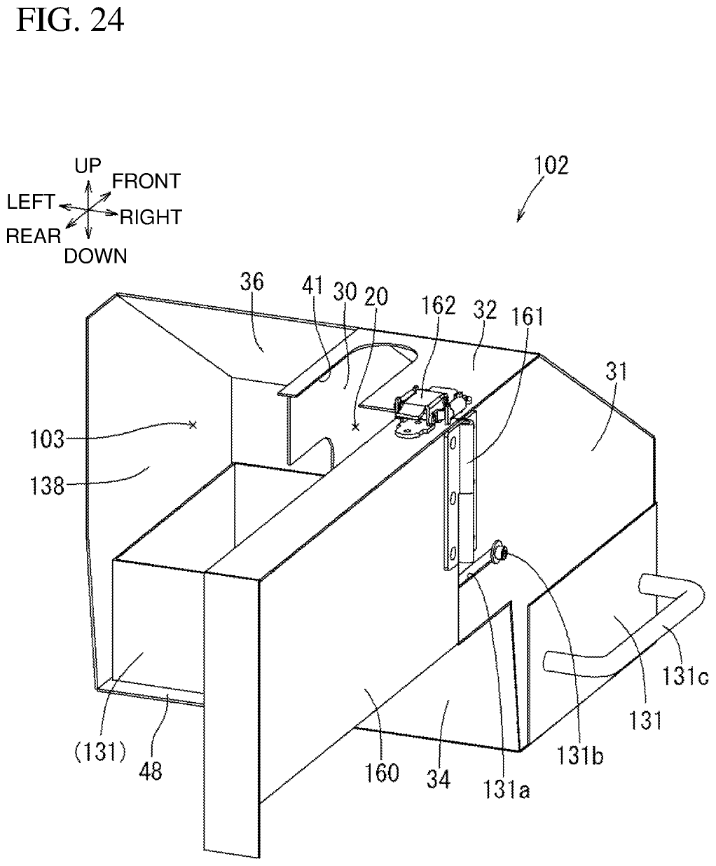

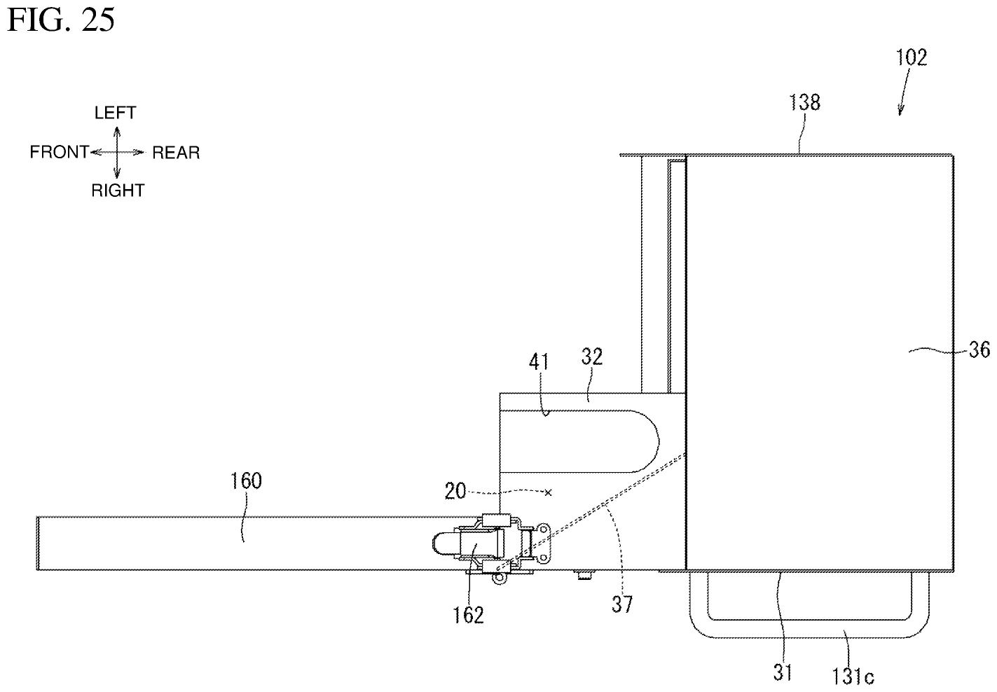

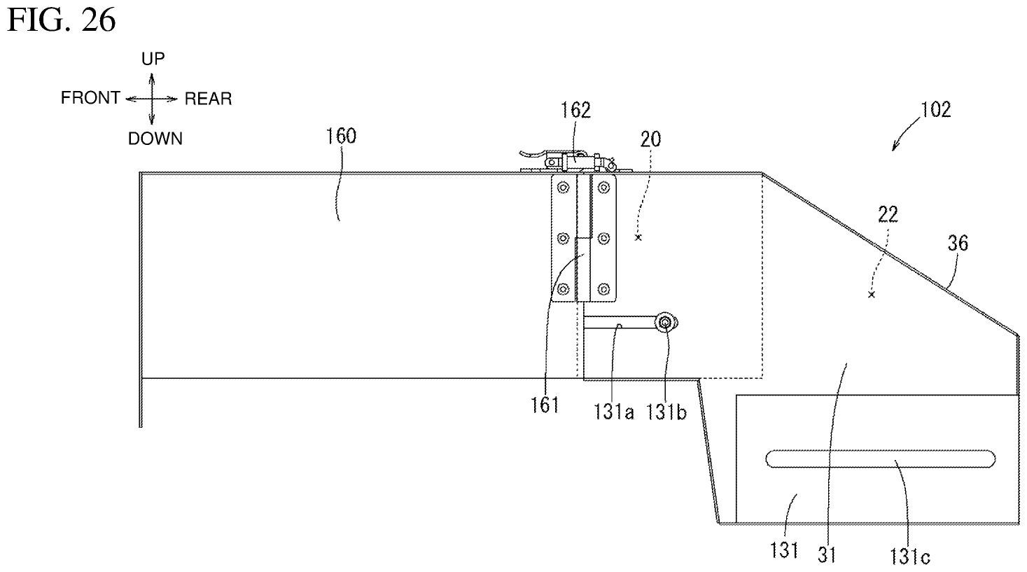

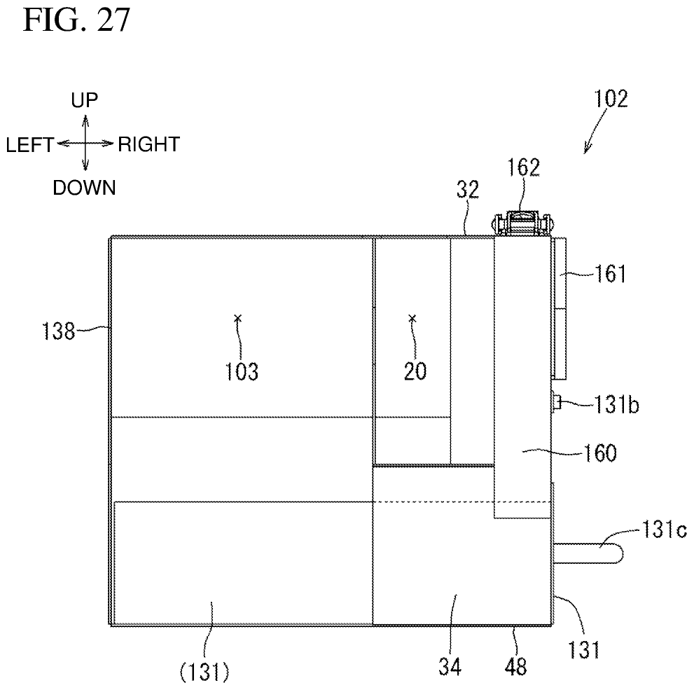

A stationary cutting machine for metalworking according to a second embodiment will now be described with reference to FIGS. 14 to 31. A dust collector box 102 according to the present embodiment can more reliably prevent scattering of sparks A generated during cutting of the workpiece than the dust collector box 2 according to the first embodiment. The components that are the same as or equivalent to those described in the first embodiment are given the same reference numerals in the drawings and will not be described repeatedly.

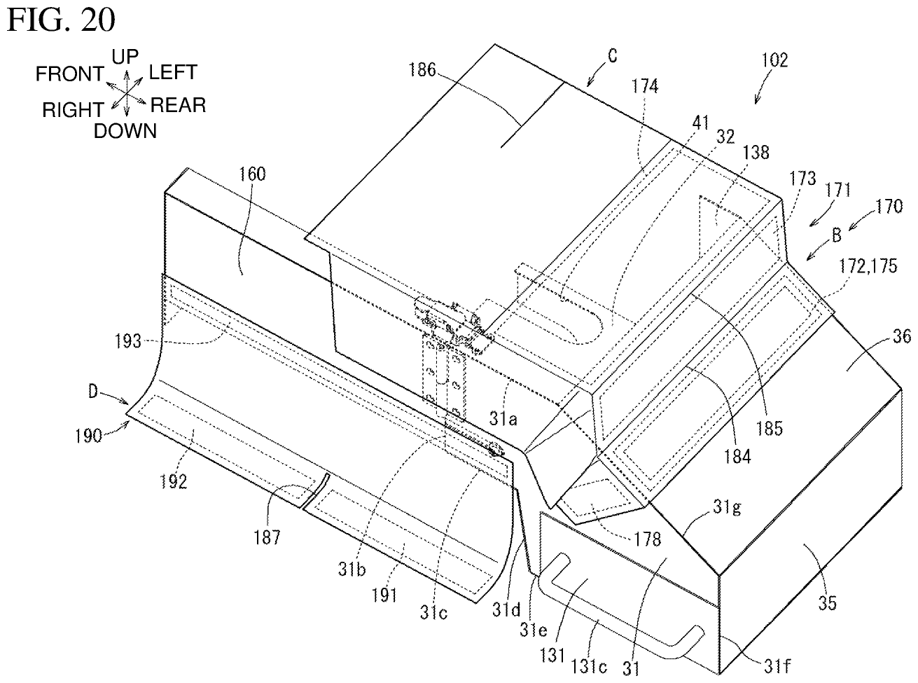

The dust collector box 102 according to the present embodiment is substantially L-shaped and hollow. Like the dust collector box 2 according to the first embodiment, the dust collector box 102 has a dust collecting port 20, an outlet port 21, and a dust collecting passage 22. The dust collecting passage 22 communicates with the dust collecting port 20 (refer to FIGS. 20 to 27). Like the dust collector box 2, the dust collector box 102 according to the present embodiment can be attached to the cutting machine 1 (refer to FIGS. 14 to 19). Referring back to FIGS. 20 to 22, the dust collector box 102 has a right side wall 31 including a shield 160 that is pivotable with a hinge 161.

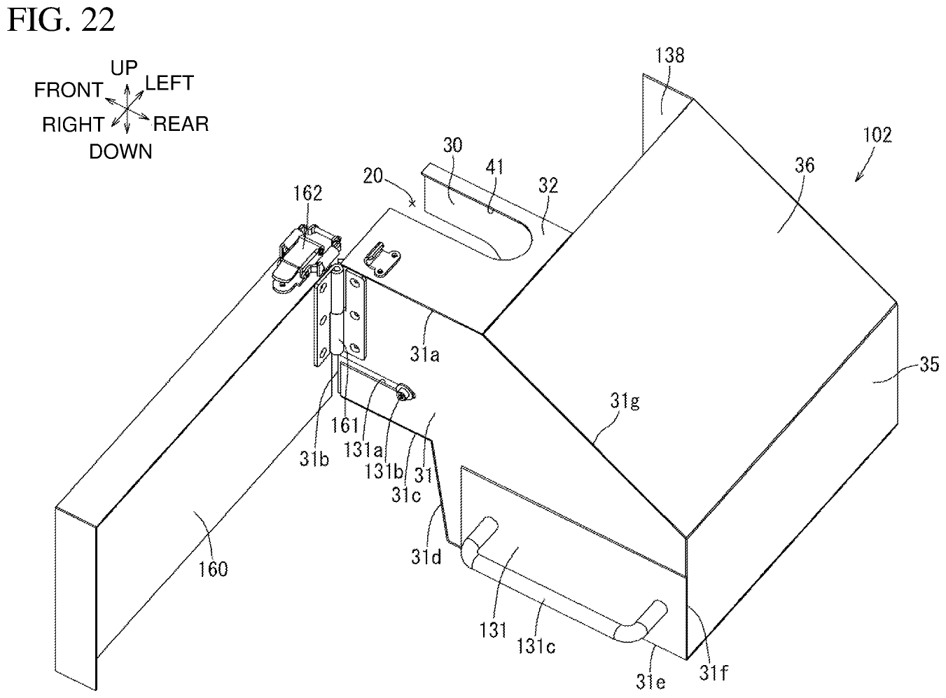

The shield 160 prevents sparks A from scattering to the right of the dust collecting port 20 during cutting of the workpiece (refer to FIG. 20). The hinge 161 allows the shield 160 to pivot rightward (refer to FIG. 22). The shield 160 can thus avoid interference with any workpiece that may extend largely rightward from the cutting machine 1. The dust collector box 102 includes a rectangular dust box 131 in the lower portion. The dust box 131 can store chips. The dust box 131 can be detached to discharge the accumulated chips. More specifically, the dust box 131 has a handle 131c to be pulled to slide the dust box 131 out of the dust collector box 102.

The dust collector box 102 has the right side wall 31 having a screw slot 131a. The dust collector box 102 can be attached and screwed to the cutting machine 1 with a screw 13 lb through the screw slot 131a. The dust collector box 102 can thus be attached to the cutting machine 1. This allows the cutting machine 1 and the dust collector box 102 to be carried together.

The dust collector box 102 has an upper wall 32 including a lock 162 for locking the shield 160 in the front-rear direction. The lock 162 locks the shield 160 of the dust collector box 102 attached to the cutting machine 1. Unlike the dust collector box 2 according to the first embodiment, the dust collector box 102 includes a rear wall 35, a sloping wall 36, and a lower slide plate 48 extending largely leftward from the left side wall 30.

The lower slide plate 48 is welded to the bottom sides 30e and 31e of the left and right side walls 30 and 31 to prevent sliding. The rear wall 35, the sloping wall 36, and the lower slide plate 48 extend largely and have their extending edges welded to an auxiliary side wall 138. Thus, an auxiliary dust collector 103 is located on the left of the dust collecting passage 22 in the dust collector box 102. The auxiliary dust collector 103 can collect chips resulting from the sparks A scattering to the left of the dust collecting port 20 of the dust collector box 102 during cutting of the workpiece.

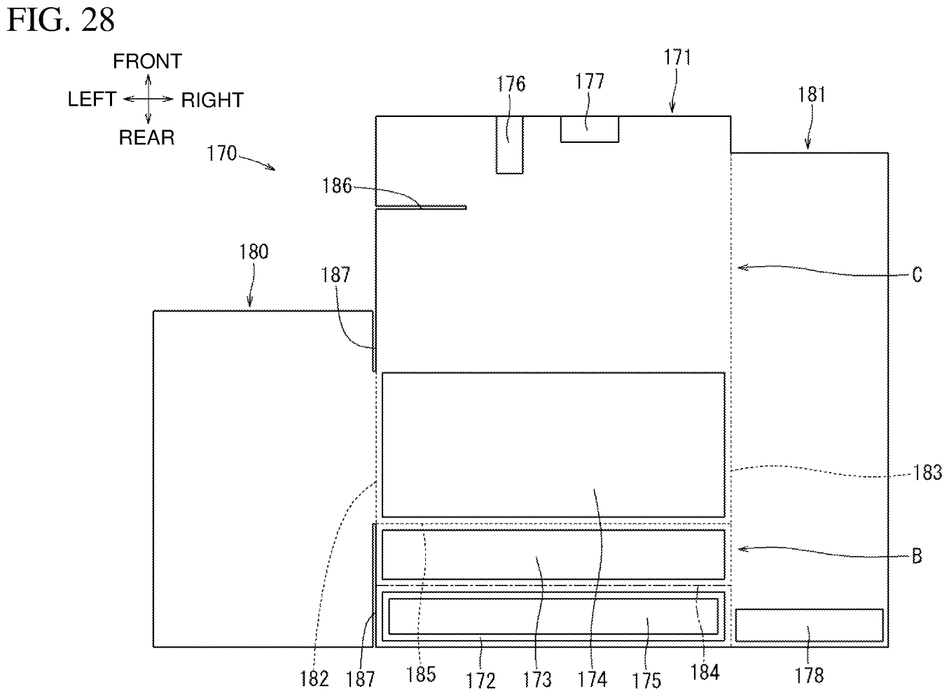

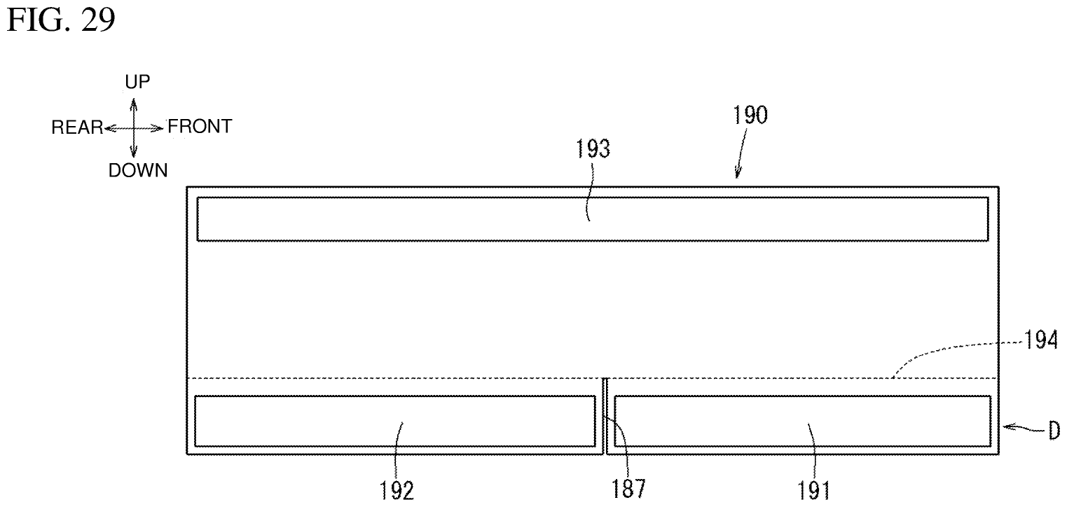

The dust collector box 102 includes a first cover 170 and a second cover 190 (refer to FIGS. 28 and 29). The first cover 170 and the second cover 190 will be described separately below.

The first cover 170 will now be described (refer to FIG. 28). The first cover 170 includes a main portion 171, a left portion 180, and a right portion 181. The main portion 171 is formed from a rectangular flame-retardant cloth. The left portion 180 is formed from a rectangular flame-retardant cloth and is continuous with the left of the main portion 171. The right portion 181 is formed from a rectangular flame-retardant cloth and is continuous with the right of the main portion 171. The first cover 170 has an inner surface coated with a flame retardant material (e.g., latex).

The first cover 170 includes a rectangular first iron plate 172, a rectangular second iron plate 173, and a rectangular third iron plate 174 attached to the inner surface in sequence from the rear toward the front. The first iron plate 172 includes a rectangular first magnet 175 attached to the inner surface. The first cover 170 includes a second magnet 176 and a third magnet 177 attached to the front part. The right portion 181 includes a rectangular fourth magnet 178 attached to the rear part.

The boundary between the main portion 171 and the left portion 180 is a mountain-fold portion 182 forming a mountain fold protruding outward. The boundary between the main portion 171 and the right portion 181 is a mountain-fold portion 183 forming a mountain fold protruding outward. The boundary between the first iron plate 172 and the second iron plate 173 is a valley-fold portion 184 forming a valley fold recessed inward.

The boundary between the second iron plate 173 and the third iron plate 174 is a mountain-fold portion 185 forming a mountain fold protruding outward. The main portion 171 has a rear part B bent with the valley-fold portion 184 and the mountain-fold portion 185. The main portion 171 has a slit 186 at the left edge near the upper end. The first cover 170 has slits 187 reaching the upper and lower ends of the mountain-fold portion 182. The first cover 170 can be unfolded into a plane and is deformable.

The first magnet 175 is fastened to the sloping wall 36 of the dust collector box 102 in the lateral direction. The main portion 171 has the rear part B bent with the valley-fold portion 184 that is valley-folded and the mountain-fold portion 185 that is mountain-folded, and has the front part C wrapping the fixed cover 18. In this state, the second magnet 176 and the third magnet 177 can be attached to the fixed cover 18 (refer to FIGS. 14 to 16). Thus, the dust collector box 102 includes the first cover 170 having the bendable main portion 171 above the dust collecting port 20.

The left and right mountain-fold portions 182 and 183 are mountain-folded, and the left and right portions 180 and 181 droop on the left and right of the dust collector box 102. In this state, the fourth magnet 178 can be attached to the right side wall 31. The slits 186 and 187 allow the first cover 170 to conform to the exterior profile of the rear part of the cutting machine 1 and the rear part of the dust collector box 102. In other words, the first cover 170 can externally cover the rear part of the cutting machine 1 and the upper rear part of the dust collector box 102. Thus, the first cover 170 can cover a gap between the rear part of the cutting machine 1 and the rear part of the dust collector box 102.

With the cutting machine 1 and the dust collector box 102 covered in this manner, the main portion 171 has the iron plates 172, 173, and 174 facing the sloping wall 36 that receives intense sparks A in the dust collector box 102. This structure improves the fire resistance of the main portion 171. In other words, the main portion 171 is prevented from burning with the sparks A hitting the sloping wall 36.

With the cutting machine 1 and the dust collector box 102 covered in this manner, the main portion 171 has the rear part B bending to follow the body 15 swinging vertically with respect to the base 10. Thus, the second magnet 176 and the third magnet 177 attached to the fixed cover 18 do not drop off. The main portion 171 thus follows the body 15 swinging vertically. The sparks A generated during cutting of the workpiece are thus prevented from scattering, independently of the vertical swinging position of the body 15.

The cover 170 also covers a gap between the parts, thus preventing scattering of sparks more reliably. The cover 170 can be detached from the exterior of the dust collector box 102 and folded in a compact manner when not in use. The cover 170 can be unfolded and either mountain-folded or valley-folded at any position to cover the cutting machine 1 and the dust collector box 102 along their exteriors substantially without any gap.

The second cover 190 will now be described (refer to FIG. 29). The second cover 190 is also formed from a rectangular flame-retardant cloth. The second cover 190 has an inner surface coated with a flame retardant material (e.g., latex), like the first cover 170. The second cover 190 includes a rectangular first iron plate 191 and a rectangular second iron plate 192 attached to the inner surface in the lower part. The second cover 190 includes a rectangular magnet 193 attached to the inner surface in the upper part. The first and second iron plates 191 and 192 have upper edges defining a valley-fold portion 194 forming a valley fold protruding outward. The boundary between the first iron plate 191 and the second iron plate 192 defines the slit 187.

The magnet 193 can be attached to the right side wall 31 of the dust collector box 102 and to the shield 160 in the front-rear direction. With the valley-fold portion 194 valley-folded, the lower part D aligns with the installation floor F. The sparks A are prevented from scattering through a gap between the lower edge of the second cover 190 and the installation floor F.

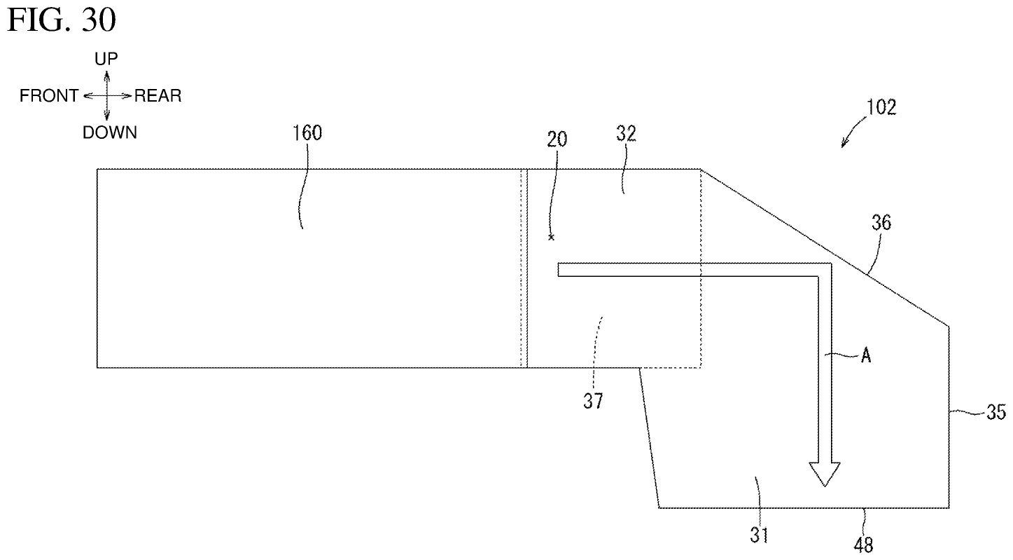

The dust collector box 102 according to the present embodiment has the effects similar to those of the dust collector box 2 according to the first embodiment. More specifically, the workpiece held on the support 11 is cut with the rotating grinding disc 17 while generating sparks A, which then scatter through the dust collecting port 20 into the dust collecting passage 22. The scattering sparks A are guided along the guide wall 37 toward the sloping wall 36. The guided sparks A hit the sloping wall 36 to be reflected downward (refer to FIG. 30). The reflected sparks A thus accumulate on the lower slide plate 48. The chips resulting from the sparks A generated during cutting can thus be collected.

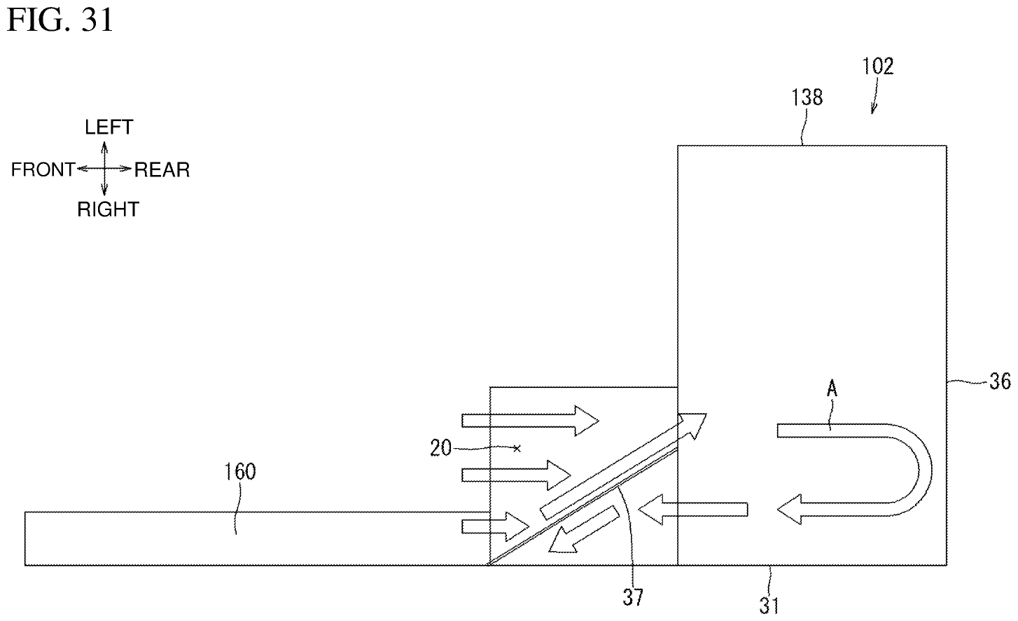

The sparks A hitting the sloping wall 36 may be partially reflected upstream (blow back) without being reflected downward. However, the guide wall 37 obstructs the dust collecting passage 22 to prevent backflow of the sparks A as described above (refer to FIG. 31). This prevents the sparks A, reflected upstream, from blowing back through the dust collecting port 20, and thus from blowing toward the operator.

The dust collector box 102 has the right side wall 31 including the shield 160 that is pivotable with the hinge 161. For normal use, the shield 160 is extended as shown in FIG. 20. For cutting off a large workpiece, the shield 160 can be pivoted as shown in FIG. 22 to prevent the workpiece from interfering with the dust collector box 102.

The first cover 170 can be unfolded into a plane and is deformable. The first cover 170 conform to the exterior profile of the rear part of the cutting machine 1 and the upper rear part of the dust collector box 102. In other words, the first cover 170 can externally cover the rear part of the cutting machine 1 and the rear part of the dust collector box 102. Thus, the first cover 170 can cover a gap between the rear part of the cutting machine 1 and the rear part of the dust collector box 102. This prevents the sparks A generated during cutting of the workpiece from scattering through such a gap.

The above embodiments may be modified further. For example, although the guide wall 37 in the first embodiment extends from the right of the dust collecting port 20 leftward and is inclined downstream, the guide may be in various other forms to mainly guide sparks into the dust collecting passage 22 and prevent backflow of sparks in the dust collecting passage 22.

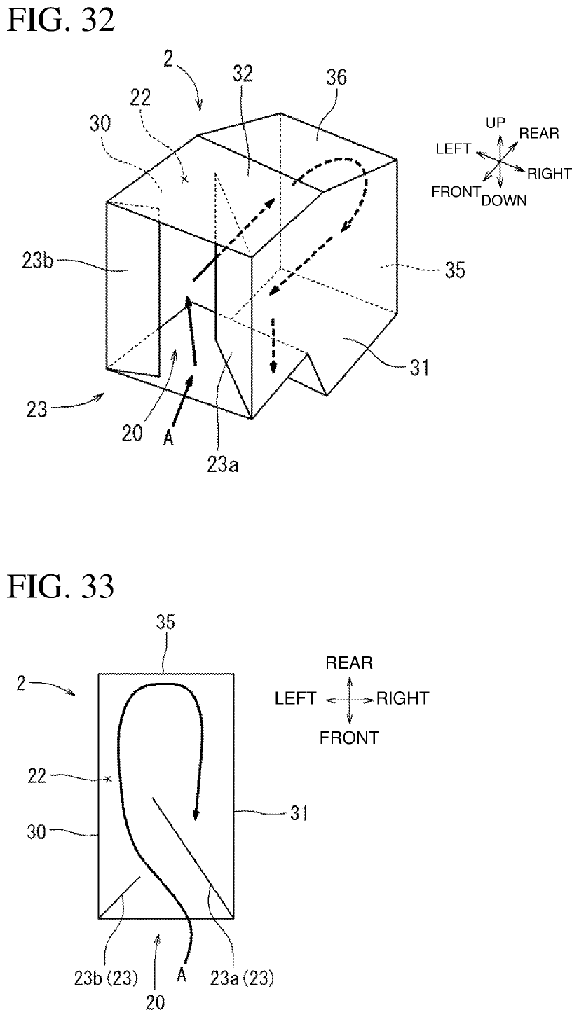

FIG. 32 and subsequent figures schematically show guides 23, 24, 25, 26, 27, 28, 38, and 39 in third to tenth embodiments located near a dust collecting port 20 inside a dust collector box 2. As shown in FIGS. 32 and 33, the guide 23 in the third embodiment includes two rectangular flat plates as guide walls 23a and 23b. In FIG. 32, the right guide wall 23a is at the right side of the dust collecting port 20, and the left guide wall 23b is at the left side of the dust collecting port 20. In other words, the two guide walls 23a and 23b are between the opposing sides of the dust collecting port 20. The two guide walls 23a and 23b have the same height spanning the entire vertical dimension, or from the bottom to the top, of the dust collecting port 20.

The right and left guide walls 23a and 23b, which are each inclined with respect to the lateral direction, are inclined downstream. In other words, the right guide wall 23a is inclined more leftward at more downstream positions, and the left guide wall 23b is inclined more rightward at more downstream positions.

The right guide wall 23a has a larger lateral width than the left guide wall 23b. Thus, the right guide wall 23a extends farther into the dust collecting passage 22 than the left guide wall 23b, as shown in FIG. 33.

The guide 23 in the third embodiment includes the right guide wall 23a to guide the spark flow A blown into the dust collecting port 20 to curve leftward and pass through the narrowed dust collecting passage 22 between the right guide wall 23a and the left side wall 30 into the inner part of the dust collector box 2. The spark flow A reaching the inner part of the dust collector box 2 is blown against the rear wall 35 and swirls clockwise.

Thus, the guide 23 in the third embodiment includes the two guide walls 23a and 23b to guide the spark flow A to swirl in the inner part of the dust collector box 2 and decelerate. This reduces backflow of the spark flow A toward the operator. The spark flow A being a swirl flow but still having momentum is blown against the rear surface of the right guide wall 23a. This reliably prevents backflow of the spark flow A toward the operator.

The right and left guide walls 23a and 23b are inclined to narrow the flow passage area of the dust collecting passage 22. This decelerates the spark flow A entering through the dust collecting port 20. Thus, the guide 23 in the third embodiment can effectively prevent backflow of the spark flow A generated with great momentum.

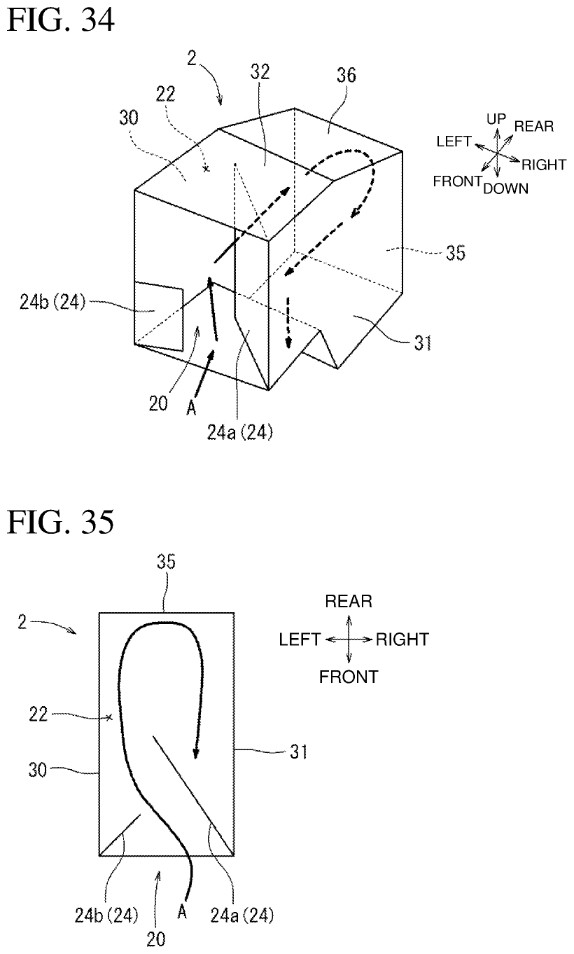

FIGS. 34 and 35 show the dust collector box 2 including the guide 24 near the dust collecting port 20 according to the fourth embodiment. The guide 24 in the fourth embodiment also includes two rectangular flat plates as guide walls 24a and 24b. The right guide wall 24a is at the right side of the dust collecting port 20, and the left guide wall 24b is at the left side of the dust collecting port 20. The right guide wall 24a has a height spanning the entire vertical dimension, or from the bottom to the top, of the dust collecting port 20. The left guide wall 24b has a height spanning substantially the lower half of the dust collecting port 20 in the vertical direction. The fourth embodiment differs from the third embodiment in that the left guide wall 24b is about half as high as the right guide wall 24a.

The right and left guide walls 24a and 24b, which are each inclined with respect to the lateral direction, are inclined downstream. In other words, the right guide wall 24a is inclined more leftward at more downstream positions, and the left guide wall 24b is inclined more rightward at more downstream positions.

The right guide wall 24a has a larger lateral width than the left guide wall 24b. Thus, the right guide wall 24a extends farther into the dust collecting passage 22 than the left guide wall 24b, as shown in FIG. 35.

The guide 24 in the fourth embodiment includes the right guide wall 24a to guide the spark flow A blown into the dust collecting port 20 to curve leftward and pass through the narrowed dust collecting passage 22 between the right guide wall 24a and the left side wall 30 into the inner part of the dust collector box 2. The spark flow A reaching the inner part of the dust collector box 2 is blown against the rear wall 35 and swirls clockwise, as in the third embodiment.

The spark flow A being a swirl flow in the inner part of the dust collector box 2 decelerates and is also blown against the rear surface of the right guide wall 24a, thus reducing backflow of sparks toward the operator.

The guide 24 in the fourth embodiment includes the left guide wall 24b about half as high as the right guide wall 24a. This structure is effective for the spark flow A having greater momentum in a lower portion than in an upper portion. The left guide wall 24b extends over substantially the lower half. The left guide wall 24b reliably guides the spark flow A having relatively small momentum in its upper portion to enter the dust collecting passage 22 without decelerating greatly. The right and left guide walls 24a and 24b may thus have vertical dimensions determined appropriately in accordance with the conditions of the spark flow A. This allows the spark flow A to be collected in the dust collector box 2 without decelerating the spark flow A greatly, thus reliably preventing backflow.

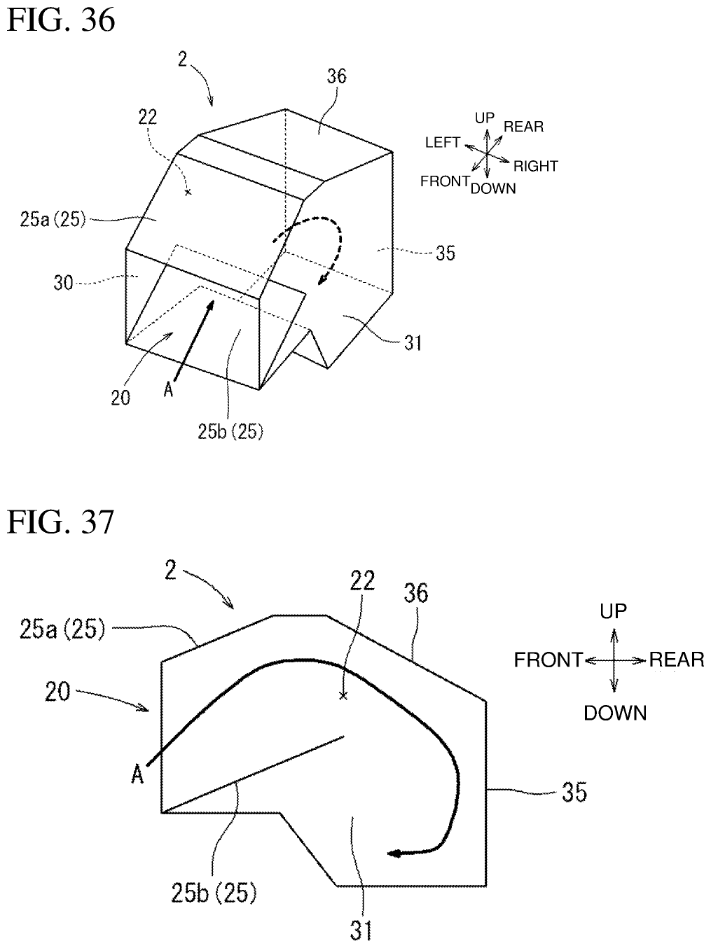

FIGS. 36 and 37 show the dust collector box 2 including the guide 25 near the dust collecting port 20 according to the fifth embodiment. The guide 25 in the fifth embodiment also includes two rectangular flat plates as guide walls 25a and 25b. The fifth embodiment differs from the third and fourth embodiments in that the two guide walls 25a and 25b are located at the top and bottom of the dust collecting port 20.

The upper guide wall 25a is at the upper side of the dust collecting port 20, and the lower guide wall 25b is at the lower side of the dust collecting port 20. In other words, the upper and lower guide walls 25a and 25b are between the opposing sides of the dust collecting port 20. The upper and lower guide walls 25a and 25b extend from the dust collecting port 20 and are inclined upward. The upper and lower guide walls 25a and 25b are parallel to each other. Thus, unlike the third and fourth embodiments, the dust collecting passage 22 is not narrowed. The upper and lower guide walls 25a and 25b each span the entire lateral dimension of the dust collecting port 20. In the fifth embodiment, the upper guide wall 25a defines the exterior of the dust collector box 2.

The guide 25 in the fifth embodiment includes the upper and lower guide walls 25a and 25b to guide, upward, the spark flow A blown into the dust collecting port 20, as shown in FIG. 37. The spark flow A guided upward is blown against the sloping wall 36 and swirls downward. This decelerates the spark flow A and prevents or reduces backflow of sparks toward the operator. The swirl flow is also blown against the rear surface of the lower guide wall 25b. This also reduces backflow of sparks toward the operator.

The guide 25 in the fifth embodiment includes the lower guide wall 25b with the inclination angle changeable to either narrow or widen the flow passage area of the dust collecting passage 22 to adjust the momentum of the spark flow A entering through the dust collecting port 20. This structure reliably enables both efficient collection of sparks and backflow prevention.

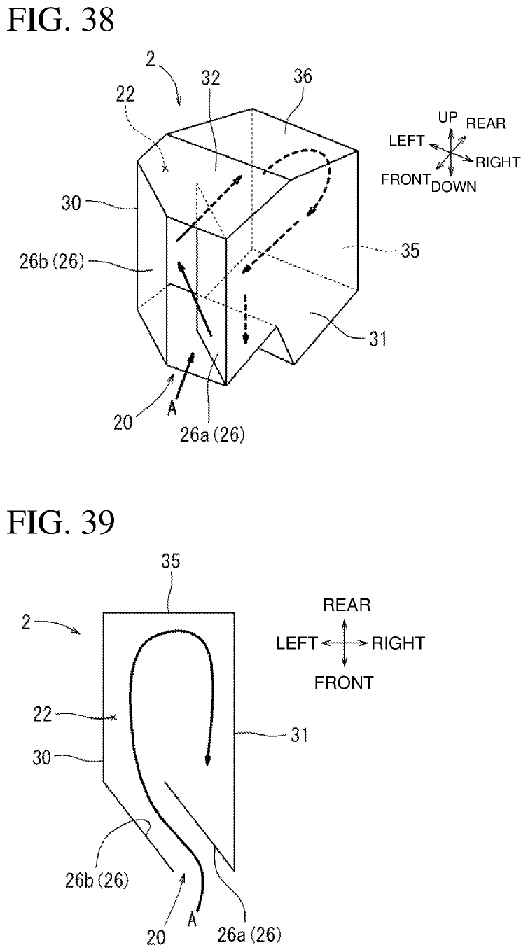

FIGS. 38 and 39 show the dust collector box 2 including the guide 26 near the dust collecting port 20 according to the sixth embodiment. The guide 26 in the sixth embodiment includes right and left guide walls 26a and 26b. The right guide wall 26a extends from the right side of the dust collecting port 20 diagonally downstream. In other words, the right and left guide walls 26a and 26b are between the opposing sides of the dust collecting port 20. The left guide wall 26b extends from the left side of the dust collecting port 20 and is inclined downstream. The left guide wall 26b defines the exterior of the dust collector box 2.

The right and left guide walls 26a and 26b are each inclined more leftward at more downstream positions, and are parallel to each other. Thus, the dust collecting passage 22 has a substantially constant flow passage area. The right and left guide walls 26a and 26b have the same height spanning the entire vertical dimension, or from the bottom to the top, of the dust collecting port 20.

The guide 26 in the sixth embodiment includes the right and left guide walls 26a and 26b to guide, leftward, the spark flow A blown into the dust collecting port 20, as shown in FIG. 39. The spark flow A guided leftward in the dust collecting passage 22 is blown against the left side wall 30 and swirls clockwise. This decelerates the spark flow A and prevents or reduces backflow of sparks toward the operator. The swirl flow is also blown against the rear surface of the right guide wall 26a. This also reduces backflow of sparks toward the operator.

Like the guide 25 in the fifth embodiment, the guide 26 in the sixth embodiment includes the right guide wall 26a having the inclination angle changeable to narrow or widen the flow passage area of the dust collecting passage 22 to adjust the momentum of the spark flow A entering through the dust collecting port 20. This structure reliably enables both efficient collection of sparks and backflow prevention.

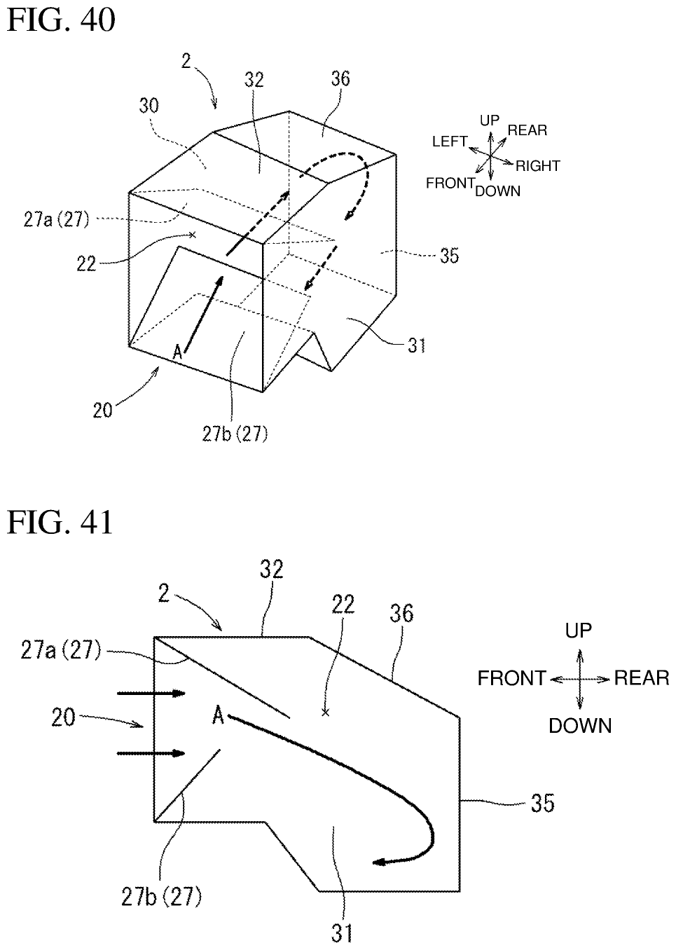

FIGS. 40 and 41 show the dust collector box 2 including the guide 27 near the dust collecting port 20 according to the seventh embodiment. The guide 27 in the seventh embodiment also includes two rectangular flat plates as guide walls 27a and 27b. The guide 27 in the seventh embodiment has the two guide walls 27a and 27b at the top and bottom of the dust collecting port 20.

The upper guide wall 27a is at the upper side of the dust collecting port 20, and the lower guide wall 27b is at the lower side of the dust collecting port 20. The upper guide wall 27a extends from the dust collecting port 20 and is inclined more downward at more downstream positions. The lower guide wall 27b extends from the dust collecting port 20 and is inclined more upward at more downstream positions. In other words, the upper and lower guide walls 27a and 27b are between the opposing sides of the dust collecting port 20. Unlike in the fifth embodiment, the dust collecting passage 22 in the present embodiment has a smaller flow passage area at more downstream positions.

As shown in FIG. 41, the upper guide wall 27a extends farther into the dust collecting passage 22 than the lower guide wall 27b. Thus, the spark flow A entering through the dust collecting port 20 swirls downward. The upper and lower guide walls 27a and 27b each span the entire lateral dimension of the dust collecting port 20. In the seventh embodiment, the upper guide wall 27a is separate from the exterior of the dust collector box 2.

The guide 27 in the seventh embodiment includes the upper and lower guide walls 27a and 27b narrowing the dust collecting passage 22 to decelerate the spark flow A blown into the dust collecting port 20, as shown in FIG. 41, thus reducing backflow of the spark flow A toward the operator. The upper guide wall 27a extends farther into the dust collecting passage 22 than the lower guide wall 27b, and thus causes the spark flow A to swirl downward. This decelerates the spark flow A and reduces backflow toward the operator more reliably. The downward swirl flow is also blown against the rear surface of the lower guide wall 27b. This also reduces backflow of sparks toward the operator.

The guide 27 in the seventh embodiment narrows the flow passage area of the dust collecting passage 22 to decelerate the spark flow A. Thus, the guide 27 may be used for a cutting machine that generates a spark flow A with relatively great momentum during cutting.

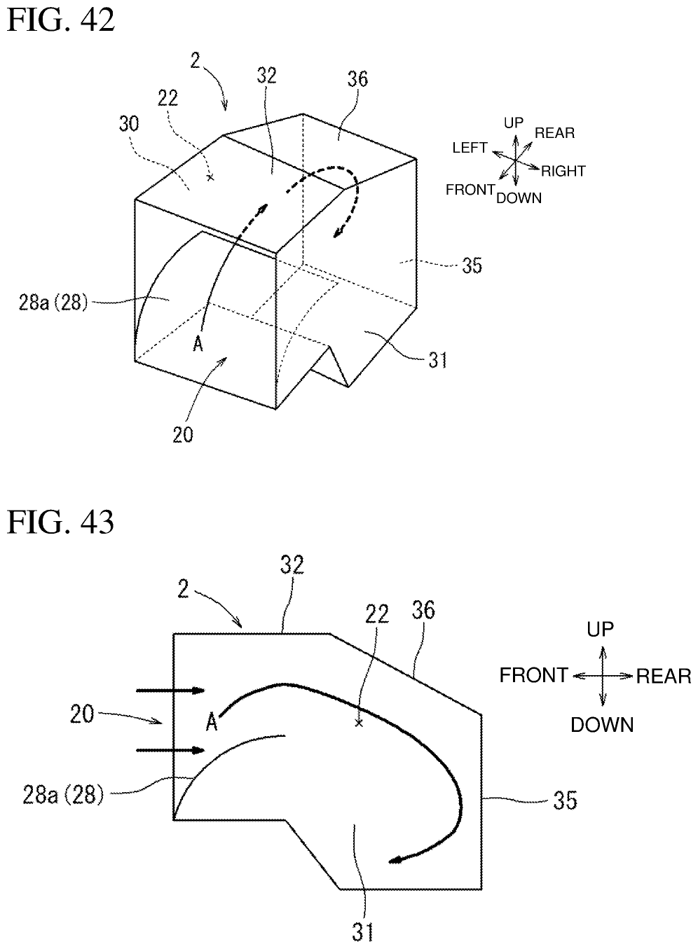

FIGS. 42 and 43 show the dust collector box 2 including the guide 28 near the dust collecting port 20 according to the eighth embodiment. The guide 28 in the eighth embodiment includes a single guide wall 28a. The guide wall 28a curves upward from the lower end of the dust collecting port 20 downstream. The guide wall 28a has an upper surface being a guide surface that is curved upward.

The guide 28 in the eighth embodiment includes the guide wall 28a having the curved guide surface, and thus reduces turbulence of the spark flow A entering through the dust collecting port 20 as compared with a guide having a flat guide surface. The spark flow A smoothly enters the dust collecting passage 22 without turbulence, and thus effectively decelerates. The curved guide wall 28a gradually narrows the dust collecting passage 22 to decelerate the spark flow A. The guide wall 28a having the curved surface and the sloping wall 36 guide the spark flow A to swirl and thus decelerate. The spark flow A being a swirl flow is also blown against the rear surface of the guide wall 28a. This structure reliably reduces backflow toward the operator.

The guide 28 in the eighth embodiment may be used for the cutting machine 1 that generates a strong air blow together with sparks, such as a tipped saw cutting machine. In this case, the guide 28 can effectively prevent turbulence of the spark flow A and reliably reduce backflow of sparks.

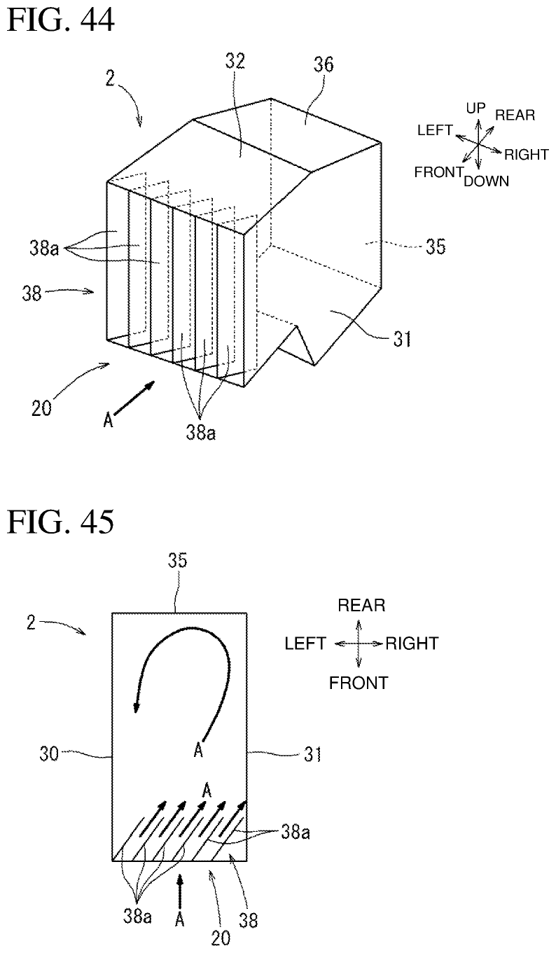

FIGS. 44 and 45 show the dust collector box 2 with the guide 38 in the ninth embodiment. The guide 38 in the ninth embodiment includes multiple (six in these figures) guide walls 38a. Each of the six guide walls 38a is a vertically elongated, rectangular flat plate. The guide walls 38a each span the entire height, or from the bottom to the top, of the dust collecting port 20. The guide walls 38a are substantially equally spaced across the entire lateral dimension, from right to left, of the dust collecting port 20. In other words, the multiple guide walls 38a are between the opposing sides of the dust collecting port 20. The guide walls 38a define vertically elongated clearances (slits) that are substantially equally spaced laterally.

Each guide wall 38a is inclined rightward toward an inner part of the dust collecting passage 22. The spark flow A thus bends rightward immediately after entering through the dust collecting port 20. Although the guide walls 38a are parallel to one another without narrowing the dust collecting passage 22, the guide walls 38a defining the laterally narrow slits decelerate the spark flow A passing through the slits.

As shown in FIG. 45, the spark flow A is guided rightward by the guide walls 38a, and is then blown against the right side wall 31 and swirls leftward, thus decelerating. The spark flow A being a swirl flow is blown against the guide walls 38a. This structure reduces backflow toward the operator.

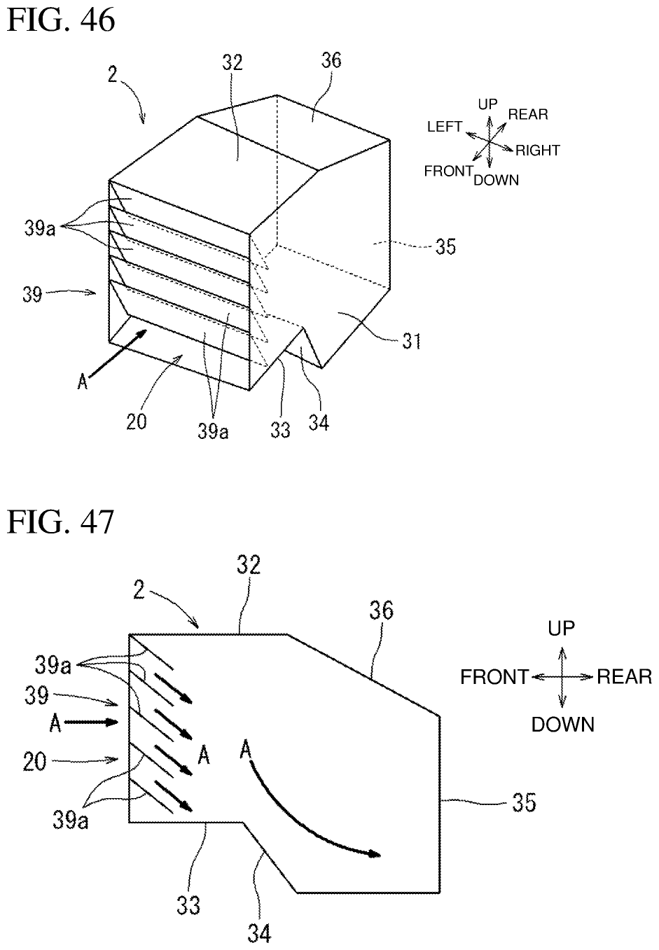

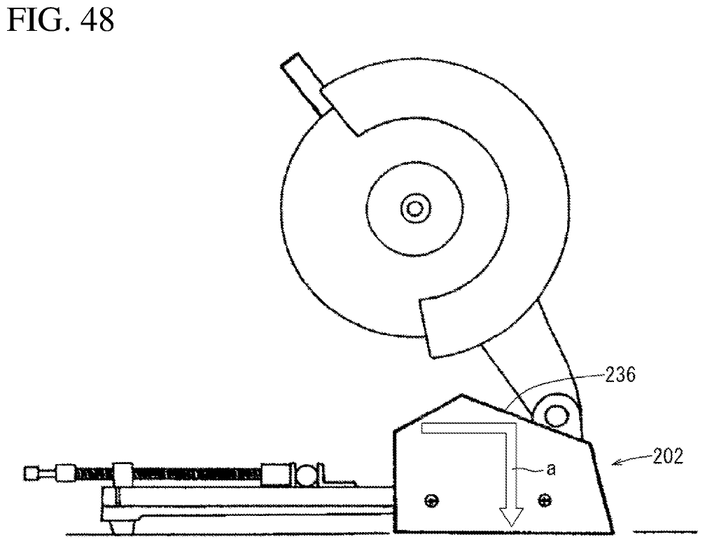

FIGS. 46 and 47 show the guide 39 in the tenth embodiment. Unlike the guide 38 in the ninth embodiment defining the vertically elongated slits that are equally spaced laterally, the guide 39 in the tenth embodiment define laterally elongated slits that are equally spaced vertically.

The guide 39 in the tenth embodiment includes five guide walls 39a. Each guide wall 39a is a laterally elongated, rectangular flat plate extending between the right and left sides of the dust collecting port 20. The guide walls 39a are substantially equally spaced across the entire vertical dimension from the bottom to the top of the dust collecting port 20. In other words, the multiple guide walls 39a are between the opposing sides of the dust collecting port 20. The guide 39 in the tenth embodiment includes the guide walls 39a defining laterally elongated slits that are substantially equally spaced vertically.

Each guide wall 39a is inclined downward toward an inner part of the dust collecting passage 22. The spark flow A is thus bent downward immediately after entering through the dust collecting port 20. Although the guide walls 39a are parallel to one another without narrowing the dust collecting passage 22, the guide walls 39a defining the vertically narrow slits decelerate the spark flow A passing through the slits.

As shown in FIG. 47, the spark flow A is guided downward by the guide walls 39a, and is then blown against the lower wall 33 below or the recessed wall 34 to swirl upward, thus decelerating. The spark flow A swirls upward and then flows along the rear wall 35 and the sloping wall 36 to the upper surface of each guide wall 39a. This structure reduces backflow toward the operator.

The guides 38 and 39 in the ninth and tenth embodiments include the guide walls 38a and 39a defining narrow slits at the dust collecting port 20. The spark flow A passing through the slits hit against more guide walls 38a and 39a at short distances from the dust collecting port 20. The guides 38 and 39 can thus effectively decelerate the spark flow A. A dust collector box having a dust collecting port with such slits in the ninth or tenth embodiment may be used for operations with relatively intense scattering of sparks. Such a dust collector box can more reliably reduce or prevent backflow of sparks toward the operator.

Like the dust collector boxes 2 according to the first embodiment, any of the dust collector boxes 2 according to the third to tenth embodiments described above may have a receiving portion in the upper portion (upper wall 32) of the dust collecting port 20 for receiving the fixed cover 18 when the body 15 swings up. The receiving portion may be covered by the upper slide plate 43 when the body 15 swings down. The upper slide plate 43 covers the receiving portion during cutting to prevent sparks from scattering through the receiving portion. The upper slide plate 43 maintains the scattering prevention despite the receiving portion.

Any of the dust collector boxes 2 according to the third to tenth embodiments may also have an outlet port 21 at the bottom. In some embodiments, the outlet port 21 may be located in the rear wall 35 or differently. The outlet port may be opened and closed with a slide as illustrated in the first embodiment, or with a cap.

Any of the dust collector boxes 2 illustrated in the third to tenth embodiments may include the shield 160, the first cover 170, and the second cover 190 illustrated in the second embodiment.

The above embodiments may be modified further. For example, the dust collector box 2 illustrated may be used with a body 15 including a tipped saw instead of the grinding disc 17. The dust collector box 2 is not limited to metal sheets, but may be formed from a heat resistant resin or a combination of both.

The first cover 170 and the second cover 190 may be formed from a sheet material other than cloth, such as a metallic fiber.

### REFERENCE SIGNS LIST

1 stationary cutting machine (cutting machine) for metalworking
2 dust collector box
10 base
11 support
12 fence
13 vise
14 swing support shaft
15 body
15a swing support
16 electric motor
16a motor housing
17 grinding disc
18 fixed cover
18a movable cover
19 handle
19a retaining chain
19b switch lever
19c power cable
20 dust collecting port
21 outlet port
22 dust collecting passage
22a straight line indicating the extending direction of the dust collecting passage
23 guide (third embodiment)
23a guide wall
24 guide (fourth embodiment)
24a guide wall
25 guide (fifth embodiment)
25a guide wall
26 guide (sixth embodiment)
26a guide wall
27 guide (seventh embodiment)
27a guide wall
28 guide (eighth embodiment)
28a guide wall
30 side wall (left side)
30a upper side
30b front side
30c lower side
30d recessed side
30e bottom side
30f rear side
30g sloping side
30h insertion slot
31 side wall (right side)
31a upper side
31b front side
31c lower side
31d recessed side
31e bottom side
31f rear side
31g sloping side
31h inner surface
32 upper wall
32a receiving portion
32b arc portion
33 lower wall
34 recessed wall
35 rear wall
36 sloping wall
37 guide wall (first embodiment)
38 guide (ninth embodiment)
38a guide wall
39 guide (tenth embodiment)
39a guide wall
40 upper guide
41 receiving portion
41a arc portion
42 stopper
42a spring-receiving hole
43 upper slide plate
44 bend
45 spring-receiving hole
46 tension spring
47 lower guide
48 lower slide plate
49 bend
50 clearance
51 clearance
102 dust collector box (second embodiment)
103 auxiliary dust collector
131 dust box
131a screw slot
131b screw
131c handle
138 auxiliary side wall
160 shield
161 hinge
162 lock
170 first cover
171 main portion
172 first iron plate
173 second iron plate
174 third iron plate
175 first magnet
176 second magnet
177 third magnet
180 left portion
181 right portion
182 mountain-fold portion
183 mountain-fold portion
184 valley-fold portion
185 mountain-fold portion
186 slit
187 slit
190 second cover
191 first iron plate
192 second iron plate
193 magnet
194 valley-fold portion
202 known dust collector box
F installation floor
A, a spark flow

1. A dust collector box installable behind a cutting blade of a stationary cutting machine for metalworking for cutting a workpiece including a metal material, the dust collector box being installable adjacent to a placement surface for the workpiece, the dust collector box comprising:
a dust collecting port configured to receive sparks generated during cutting of the workpiece;
a dust collecting passage through which the sparks received at the dust collecting port are to flow rearward; and
a guide configured to guide the sparks into the dust collecting passage, the guide being configured to prevent the sparks entering the dust collecting passage from flowing back to the dust collecting port.

2. The dust collector box according to claim 1, wherein the guide narrows a flow passage area of the dust collecting passage downstream in the dust collecting passage.

3. The dust collector box according to claim 2, wherein
the guide includes a guide wall being flat, and
the guide wall is inclined with respect to a direction in which the sparks flow.

4. The dust collector box according to claim 1, further comprising:
a receiving portion configured to receive a body of the stationary cutting machine to avoid interference between the body and the dust collector box, the body including the cutting blade and being swingable.

5. The dust collector box according to claim 4, wherein
the receiving portion is covered in response to the body swinging for cutting.

6. The dust collector box according to claim 1, further comprising:
a dust collector configured to store chips including the sparks cooled and solidified, the dust collector having an outlet port through which the chips are to be discharged.

7. The dust collector box according to claim 1, further comprising:
a shield movable to a position at which the shield extends frontward from the dust collecting port to shield a side of the cutting blade.

8. The dust collector box according to claim 1, further comprising:
a cover including a flame-retardant cloth, the cover including a mountain-fold portion and a valley-fold portion to be bendable with the mountain-fold portion and the valley-fold portion.

9. The dust collector box according to claim 1, wherein
the guide includes a plurality of guide walls inclined with respect to a direction in which the sparks flow, and
the plurality of guide walls are between opposing sides of the dust collecting port.

10. The dust collector box according to claim 9, wherein the plurality of guide walls are inclined toward one another.

11. The dust collector box according to claim 10, wherein the plurality of guide walls have dimensions from the dust collecting port, and the dimensions differ from one another.

12. The dust collector box according to claim 9, wherein the plurality of guide walls are inclined in the same direction.

13. The dust collector box according to claim 1, wherein
the guide includes a guide wall curved upward from an end of the dust collecting port downstream.

14. A dust collector box installable behind a cutting blade of a stationary cutting machine for metalworking for cutting a workpiece including a metal material, the dust collector box being installable adjacent to a placement surface for the workpiece, the dust collector box comprising:
a dust collecting port configured to receive sparks generated during cutting of the workpiece;
a dust collecting passage through which the sparks received at the dust collecting port are to flow rearward;
a guide configured to guide the sparks into the dust collecting passage, the guide being configured to prevent the sparks entering the dust collecting passage from flowing back to the dust collecting port; and
a receiving portion configured to receive a body of the stationary cutting machine to avoid interference between the body and the dust collector box, the body including the cutting blade and being swingable, the receiving portion being covered in response to the body swinging for cutting.

15. A stationary cutting machine for metalworking, comprising:
a body including a circular cutting blade for cutting a workpiece including a metal material;
a base having a placement surface on which the workpiece is placeable; and
the dust collector box according to claim 1.

16. The dust collector box according to claim 2, further comprising:
a receiving portion configured to receive a body of the stationary cutting machine to avoid interference between the body and the dust collector box, the body including the cutting blade and being swingable.

17. The dust collector box according to claim 3, further comprising:
a receiving portion configured to receive a body of the stationary cutting machine to avoid interference between the body and the dust collector box, the body including the cutting blade and being swingable.

18. The dust collector box according to claim 2, further comprising:
a dust collector configured to store chips including the sparks cooled and solidified, the dust collector having an outlet port through which the chips are to be discharged.

19. The dust collector box according to claim 3, further comprising:
a dust collector configured to store chips including the sparks cooled and solidified, the dust collector having an outlet port through which the chips are to be discharged.

20. The dust collector box according to claim 4, further comprising:
a dust collector configured to store chips including the sparks cooled and solidified, the dust collector having an outlet port through which the chips are to be discharged.
